(19) United States
(12) Patent Application Publication
(10) Pub. No.: US 2026/0130496 A1
(43) Pub. Date: May 14, 2026

(54) WORK TABLE

(71) Applicant: Arete Outdoors, Inc., North Hollywood, CA (US)

(72) Inventors: Matthew Pennington, Los Angeles, CA (US); Jeffrey Hopkins, North Hollywood, CA (US); Michael Devereaux, North Hollywood, CA (US)

(21) Appl. No.: 19/119,058

(22) PCT Filed: Sep. 21, 2023
(86) PCT No.: PCT/US2023/074745

§ 371 Date: Apr. 7, 2025

Related U.S. Application Data
(60) Provisional application No. 63/378,558, filed on Oct. 6, 2022.

(51) Int. Cl. A47B 3/08; A47B 9/14; A47B 83/04

(52) U.S. Cl. CPC A47B 3/08; A47B 9/14; A47B 83/04; A47B 3/0818; A47B 2003/0827; A47B 2200/0052

(57) ABSTRACT

A collapsible table is provided. The table includes a top portion, a bottom portion, a first set of legs, and a second set of legs. Each set of legs are interconnected by a cross bar at one end and rotatably coupled to the ends of the bottom surface of the first portion at an opposing end. Two sets of arms are attached to the cross bars and rotatably coupled to the bottom surface of the second portion. In a deployed configuration, both sets of legs extend from the bottom surface of the first portion, and both sets of arms extend in opposite directions, positioning the second portion horizontally distant from the first portion. In a collapsed configuration, both sets of legs and both sets of arms fold such that each are adjacent to the bottom surfaces, positioning the second portion adjacent to the first portion.

### CROSS-REFERENCE TO RELATED APPLICATIONS

The present application is a national stage filing and continuation-in-part of international patent application Serial No. PCT/US2023/74745, filed on Sep. 21, 2023, which claims priority to and the benefit of U.S. Provisional Patent Application No. 63/378,558 , filed on Oct. 6, 2022. The technical disclosures of all of these applications are incorporated herein by reference in their entireties for all purposes.

### BACKGROUND

A number of table designs exist. Some permit the collapse of the table for storage. However, many of the collapsible tables provide only specific table configurations, and are usually limited to a top, flat table surface with legs extending downward therefrom. In addition, most collapsible tables have some cross bar or support structure that extends between a lower surface of the table to one or more of the legs.

### SUMMARY

This summary provides a discussion of aspects of certain embodiments of the invention. It is not intended to limit the claimed invention or any of the terms in the claims. The summary provides some aspects, but there are aspects and embodiments of the invention that are not discussed here.

In one aspect, a table is provided. The table can include a first portion having a top surface and a bottom surface, a second portion having a top surface and a bottom surface, a first set of legs rotatably coupled at their proximal ends to a first end of the bottom surface of the first portion, and a second set of legs rotatably coupled at their proximal ends to a second end of the bottom surface of the first portion. The first set of legs can be coupled together at their distal ends via a first cross bar, and the second set of legs can be coupled together at their distal ends via a second cross bar. The table can also include a first set of arms coupled to the first cross bar at their distal ends, and rotatably coupled to the bottom surface of the second portion at their proximal ends. The table can also include a second set of arms coupled to the second cross bar at their distal ends, and rotatably coupled to the bottom surface of the second portion at their proximal ends.

The table can be in a deployed configuration when the first set of legs extend in a first direction away from the bottom surface of the first portion, and the first set of arms extend in a second direction, parallel to the bottom surface of the second portion, and are adjacent to the bottom surface of the second portion. The second set of legs extend in the first direction from the bottom surface of the first portion, and the second set of arms extend in a third direction, opposite to the second direction, and are adjacent to the bottom surface of the second portion. The first and second sets of legs extending in the first direction positions the second portion horizontally distant from the first portion.

The table can be in a collapsed configuration when the first set of legs extend in the third direction and are adjacent to the bottom surface of the first portion, and the first set of arms extend in the third direction and are adjacent to the bottom surface of the second portion. The second set of legs extend in the second direction and are adjacent to the bottom surface of the first portion, and the second set of arms extend in the second direction and are adjacent to the bottom surface of the second portion. The first set of legs extending in the third direction and the second sets of legs extending in the second direction positions the second portion horizontally adjacent to the first portion.

In one embodiment, the bottom surface of the second portion can include an engagement interface configured to secure the distal ends of the first set of arms, the distal ends of the second set of arms, or a combination thereof to the second portion in the deployed configuration. The engagement interface can include at least one magnet, and one or more of the distal ends of the first and second sets of arms comprises a ferrous material. Additionally, or alternatively, the bottom surface of the second portion can include a first engagement interface at its first end and a second engagement interface at its second end. The first engagement interface can be configured to secure the distal ends of the first set of arms, and the second engagement interface can be configured to secure the distal ends of the second set of arms.

The first engagement interface can include a first set of magnets corresponding to the distal ends of the first set of arms, and the second engagement interface comprises a second set of magnets corresponding to the distal ends of the second set of arms. The distal ends of the first set of arms can include a ferrous portion configured to magnetically couple to the first set magnets, and the distal ends of the second set of arms comprises a ferrous potion configured to magnetically couple to the second set magnets. Alternatively, the first engagement interface can include a first press-fit mechanism configured to receive a portion of the distal ends of the first set of arms, and the second engagement interface can include a second press-fit mechanism configured to receive a portion of the distal ends of the second set of arms.

Each leg of the first and second sets of legs can include telescoping extensions configured to extend from distal ends of the legs to adjust a height of the legs. The first and second sets of legs can be oriented an angle of more than 90° from the bottom surface of the first portion in the deployed configuration.

The first set of arms can be rotatably coupled to the bottom surface of the second portion via a third cross bar, and the second set of arms can be rotatably coupled to the bottom surface of the second portion via a fourth cross bar.

One or more lateral surfaces of the first portion can include a railing configured to receive an engagement interface. The railing can be a T-slot extending along at least a portion of the one or more lateral surfaces.

The first portion can have one or more apertures formed from its top surface to its bottom surface and configured for receiving a receptacle therethrough.

One or more lateral surfaces proximate the first and second ends of the first portion can include an engagement interface having a channel configured support a receptacle.

In another aspect, a method of operating a table between a collapsed configuration and a deployed configuration is provided. The table can have a first portion, a second portion, a first set of legs coupled to the first portion, a second set of legs coupled to the first portion, a first set of arms coupled to the first set of legs, and a second set of arms coupled to the second set of legs. The method can include applying a first pulling force on a first cross bar interconnecting distal ends of the first set of legs such that the first set of legs rotate at a bottom surface of the first portion to extend in a first direction perpendicular to the bottom surface of the first portion. In response to the first pulling force, the first set of arms coupled at their distal ends to the first cross bar, and wherein said first set of arms begin adjacent to a bottom surface of the second portion, are then caused to rotate at their proximal ends that are coupled to the bottom surface of the second portion to extend in a second direction, parallel to the first and second portions, such that the first set of arms, after rotating approximately 180 degrees, are again adjacent to the bottom surface of the second portion. The method can also include applying a second pulling force, opposite to the first pulling force, on a second cross bar interconnecting distal ends of the second set of legs such that the second set of legs rotate at a bottom surface of the first portion to extend in the first direction. In response to the second pulling force, the second set of arms coupled at their distal ends to the second cross bar, and wherein said second set of arms begin adjacent to the bottom surface of the second portion, are then caused to rotate at their proximal ends that are coupled to the bottom surface of the second portion to extend in a third direction, opposite to the second direction, such that the second set of arms, after rotating approximately 180 degrees, are again adjacent to the bottom surface of the second portion. The application of the first and second pulling forces thereby horizontally spaces the second portion from the first portion.

The first portion and second portion can be substantially parallel prior to and after application of the first and second pulling forces.

The method can include, prior to applying the first pulling force, placing a top surface of the first portion of the table against a surface. Additionally, or alternatively, the method can include, after applying the first pulling force and the second pulling force, extending telescoping parts of the first and second sets of legs.

In one embodiment, in response to the first pulling force, distal ends of the first set of arms are coupled to a retaining mechanism at a first end of the bottom surface of the second portion, and, in response to the second pulling force, distal ends of the second set of arms are coupled to a retaining mechanism at a second end of the bottom surface of the second portion. The method can also include applying a third pulling force, opposite to the first pulling force, on the first cross bar such that the first set of legs rotate at the bottom surface of the first portion to extend in the third direction until the first set of legs are left lying adjacent to the bottom surface of the first portion in a collapsed position. In response to the third pulling force, the first set of arms are thereby rotated at their proximal ends to extend in the third direction such that the first set of arms, after rotating approximately 180 degrees, are again adjacent to the bottom surface of the second portion at their started, collapsed position. The method can also include applying a fourth pulling force, opposite to the second pulling force, on the second cross bar such that the second set of legs rotate at the bottom surface of the first portion to extend in the second direction until the second set of legs are left lying adjacent to the bottom surface of the first portion in a collapsed position. In response to the fourth pulling force, the second set of arms are thereby rotated at their proximal ends to extend in the second direction such that the second set of arms, after rotating approximately 180 degrees, are again adjacent to the bottom surface of the second portion at their started, collapsed position.

The method can also include prior to applying the third pulling force, applying a first pushing force on the first end of the bottom surface of the second portion and towards the first portion, thereby disconnecting the coupling between the retaining mechanism and the distal ends of the first set of arms. The method can also include prior to applying the fourth pulling force, applying a second pushing force on the second end of the bottom surface of the second portion and towards the first portion, thereby disconnecting the coupling between the retaining mechanism and the distal ends of the second set of arms.

### BRIEF DESCRIPTION OF THE DRAWINGS

This disclosure is facilitated by reference to the following drawing figures, in which like numerals represent like items throughout the figures.

FIGS. 1 and 2 provide an illustration of a first embodiment of a table according to the present solution.

FIG. 3 provides a bottom perspective view of the table of FIGS. 1-2 in a collapsed configuration.

FIGS. 4A-4C provide illustrations that are useful for understanding how the table of FIGS. 1-3 is transitioned from a deployed or expanded configuration to a stowed or collapsed configuration.

FIGS. 5A-5F (collectively referred to herein as “FIG. 5”) provide illustrations of the table of FIGS. 1-4C and components thereof.

FIGS. 6A-6F (collectively referred to herein as “FIG. 6”) provide illustrations that are useful for understanding how leg portions of the table of FIGS. 1-5 transition from an expanded position to a collapsed position.

FIGS. 7A-7B (collectively referred to herein as “FIG. 7”) provide illustrations of a truck tail gate having a collapsible table according to the first embodiment of a table in accordance with the disclosed principles.

FIGS. 8A-8B (collectively referred to herein as “FIG. 8”) provide illustrations of an embodiment of a hinge according to the present solution.

FIG. 9 provides an illustration of another embodiment of a table in accordance with the disclosed principles with accessories coupled thereto.

FIG. 10 provides a perspective view of the table shown in FIG. 9.

FIGS. 11A-11B (collectively referred to herein as “FIG. 11”) provide a flow diagram of an illustration method for operating a first embodiment of a table in accordance with the disclosed principles.

FIG. 12 depicts an alternate embodiment of a table in accordance with the disclosed principles in a first deployed configuration.

FIGS. 13A-13E (collectively referred to herein as “FIG. 13”) depicts the table of FIG. 12 transitioning from a collapsed configuration to a deployed configuration.

FIGS. 14A-14C (collectively referred to herein as “FIG. 14”) depicts an engagement between a set of arms and the second portion of the table of FIGS. 12-13.

FIG. 15 depicts an offset side view of the table of FIGS. 12-14 in a deployed configuration.

FIG. 16 depicts an offset front view of the table of FIGS. 12-15 in a deployed configuration.

FIG. 17 depicts the table of FIGS. 12-16 in a deployed configuration as view from an upside down orientation.

FIG. 18 provides a flow diagram of an illustration method for operating a second embodiment of a table in accordance with the disclosed principles.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure but is merely representative of certain implementations in different scenarios. While the various aspects are presented in the drawings, the drawings are not necessarily drawn to scale unless specifically indicated.

Reference throughout this specification to features, advantages, or similar language does not imply that all the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present solution concerns novel table configurations and methods of collapsing and/or expanding a table for storage. The present solution may include any combination of the features described herein. Embodiments described herein include a combination with all features present for the sake of ease of explanation. However, the embodiments of the current solution are not so limited. Each feature may be used in a table design by itself and not with other features, or may be used with any combination of features and remain within the scope of the invention. For example, a table described herein may include any combination of: a collapsible table, a non-collapsible table, a table comprising a top surface, a table comprising a lower shelf, a table having handles, a table having a top surface having one or more apertures therethrough, a table having indentations or contoured perimeter, a table having an exterior edge having one or more shaped indentations thereon, a table having a pivotable leg(s), a table having pivotable legs that are coupled in pairs to move together, legs having a cross beam thereon to support a lower shelf, the lower shelf configured to slide along the table legs, the legs pivotably coupled to an underside of the top surface, the pivotably coupled legs comprising a spring so that the legs are extended or pushed relative to a pivot in order to pivot and/or lock the legs relative to the top surface, telescoping legs, lockable legs, legs configured to translate relative to the top surface before being able to rotate to a collapsed configuration, top surface with overhung edge past legs with legs toward an interior so that the overhang can mate with a flanged holder (such as in the tail gate example but which can be used in other storage scenarios), and combinations thereof.

Although embodiments of the invention may be described and illustrated herein in terms of a table having all of the features possible, it should be understood that embodiments of this invention are not so limited, but are additionally applicable to tables have any subset of features described herein. Furthermore, although embodiments of the invention may be described and illustrated herein in terms of a rectangular table, it should be understood that embodiments of the invention are also applicable to other shapes, such as ovoid, square, circular, etc. and may also include various sizes.

The present solution may include a novel hinge configuration. The hinge permits the rotational movement of an extension portion at orthogonal angles. At the ends of the rotated positions (a first position and a second position, orthogonal to the first position), the extension is configured to be positioned within a body portion so that the extension portion is fully enclosed by the collar on all sides of the extension. In other words, the collar fully circumscribes an exterior perimeter of the extension. The extension is then configured to be moved relative to the body portion so that the extension is removed from the enclosure of the body portion and repositioned therein to be positioned in a second enclosure of the body portion. The hinge configuration may include, but is not limited to, locking mechanisms. For example, the hinge may include pins, spring pin, apertures, mated surfaces, hook-eye, etc. The novel hinge configuration can be used in other applications other than with a table as described herein.

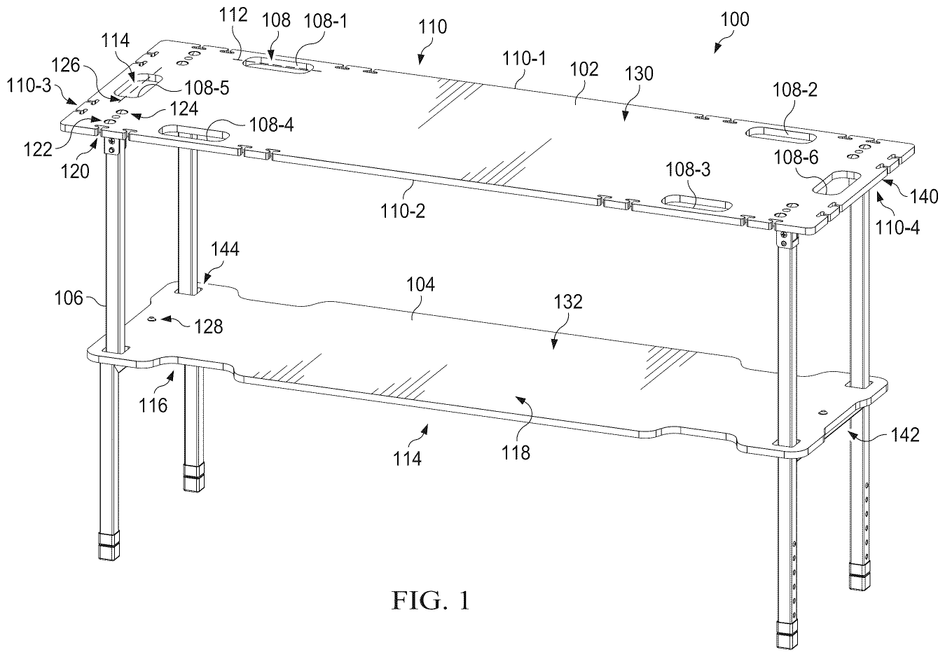

FIG. 1 provides an illustration of a table 100 according to the present solution. Table 100 has an upper part 102, a lower part 104, and four legs 106. The legs 106 (i) extend between the upper part 102 and the lower part 104, and (ii) extend past the lower part 104 to support the upper and lower parts 102, 104 above the ground, floor, or other object there below

The upper part 102 has aperture(s) 108 formed therethrough. The aperture(s) 108 are located adjacent to an outer perimeter of the upper part 102. Each aperture 108 may comprise an elongated hole with a longer dimension aligned with an edge 110 of the table to which the aperture is adjacent.

As shown in FIG. 1, the upper part 102 may include six large apertures 108-1, 108-2, 108-3, 108-4, 108-5, 108-6 formed therein to provide handles for gripping and moving the table 100. The present solution is not limited in this regard. Any number of apertures can be provided in accordance with any given application. Each aperture 108-1, 108-2, 108-3, 108-4 has a major axis 112 that extends parallel to a given long edge 110-1, 110-2 of the table. Each aperture 108-5, 108-6 has a major axis 114 that (i) extends parallel to a given short edge 110-3, 110-4 of the table and (i) extends perpendicular to the long edges 110-1, 110-2 of the table. The apertures are illustrated as curved rectangular or ovoid holes within the upper part 102. The present solution is not limited in this regard. The apertures may have other shapes such as rectangular, square, etc. The apertures may be fully enclosed by the upper part 102 as shown, or alternatively only partially enclosed by the upper part 102 (not shown). For example, the apertures may comprise a “T” opening from the perimeter edge of the table, or some other shape or configuration.

The lower part 104 may be used to define a shelf or second layer of the table 100. The lower part 104 may be separated from the upper part 102 to define two separate supporting structures for the table 100. The lower part 104 has a perimeter shape which approximates the perimeter shape of the upper part 102. The approximation may be the same shape as the upper part 102 with variations thereto, such as having different indentations from those of the upper part 102. For example, the upper part 102 and lower part 104 may be generally rectangular, square, circular, ovoid, etc.

As illustrated, the lower part 104 may include a contoured outer perimeter 114. The contouring may include indentations 116 within the outer perimeter such that portions of the outer perimeter extend inward toward the middle 118 of the lower part 104. The indentations 116 may align with the apertures 108 of the upper part 102. Therefore, when viewed from above, or when the upper part 102 is positioned vertically adjacent to the lower part 104, the indentations 116 of the lower part 104 align with the apertures 108 of the upper part 102 so that the apertures of the upper part are not obstructed by any structure of the lower part 104. This (i) allows objects (not show) to pass through the apertures 108 the upper part 102 to the ground without being obstructed by the lower part 104, and (ii) allows the apertures 108 to be used as handles when the table is either an expanded configuration or a collapsed configuration.

An inside portion of each indentation 116 may approximate an inside portion of a respective aperture 108 of the upper part 102 so that the inside edge of the respective aperture and the inside edge of the indentation are parallel or aligned when the upper part 102 is in contact with the lower part 104. Each indentation 116 may extend inward of the lower part 104 to a greater extent than the respective aperture 108 of the upper part 102. Therefore, the upper part 102 may create a flanged edge relative to the lower part 104 when the lower part and upper part are in contact with each other. In other words, an inside edge of the respective aperture may extend further away from a center axis perpendicular from the point of measurement on the top part than an inside edge of the indentation corresponding to the aperture of the upper part measured from the center axis on the lower part corresponding (or aligned with) at a point corresponding with the point on the center axis aligned with the measurement point from the upper part. The indentations on the lower part are flared outward so that the length of the indentation (the gap or distance between perimeter edges) at the outermost perimeter is greater than at the indentation toward the middle of the lower part.

Other apertures 120, 122, 124, 126, 128 may be provided on the upper part 102 and/or lower part 104. The apertures 120-128 may be configured to assist with carrying the table 100, securing the table 100 in a stowed or collapsed configuration, and/or provide accessory holders. These apertures may comprise different shapes and may be openings provided at any location on the table 100. One or more of the apertures 108, 120-126 may provide a bottle opening or hook. The accessories can include, but are not limited to, T-Slot rack extensions for wall mounts in truck beds, a plate carrier, a utensil carrier, a drying rack, a cup holder, storage bins, a bottle opener, and/or hooks (e.g., for hanging bags or other items).

For example, apertures 120-126 may be used as attachment points for accessories and other objects. In this way accessories and other objects can be removably attached to the table 100 via hooks, hangers and/or other mechanical couplers.

Apertures 120 may have a generally T-shape formed by two parallel extending slots formed through the table. The present solution is not limited in this regard. The apertures can have other shapes selected in accordance with a given application. For example, one or more apertures 120 can alternatively have a Y-shape.

Apertures 122, 124, 126, 128 can each include a single hole or slot sized and shaped to receive at least a portion of an external accessory or other object. Two or more apertures 122, 124, 126 may be located adjacent to, near or proximate each other to form a set or group of apertures. The set or group of apertures may be sized, shaped and have relative locations to accommodate at least a portion of a multi-prong coupling structure of an external accessor or object.

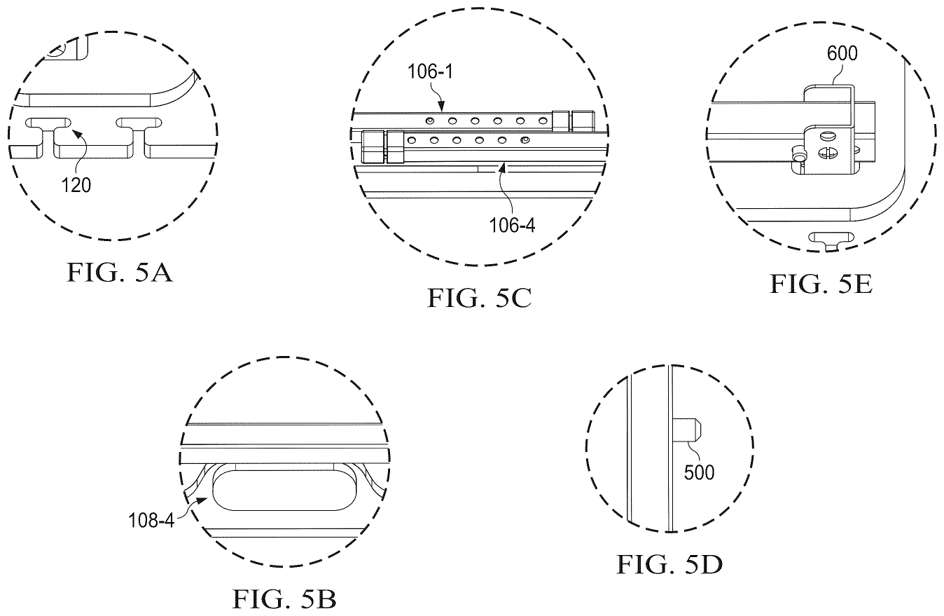

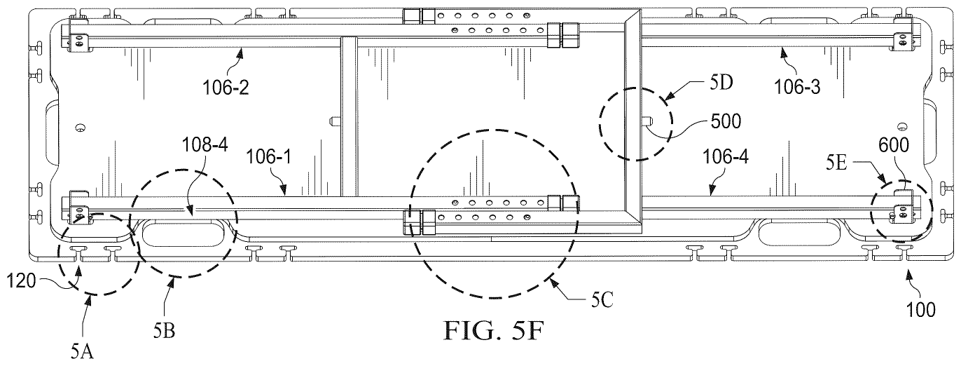

Aperture 128 may provide a means for securing the lower part 104 to the leg assembly. For example, a pin 500 (shown in FIG. 5) can be provided with the leg assembly for insertion into the aperture 128 when the lower part 104 is adjacent to cross bars of the leg assembly. The pin 800 will slide out of aperture 128 when the lower part 104 is lifted or otherwise moved towards the upper part 102.

In FIG. 1, table 100 is shown in an expanded configuration with the upper part 102 providing a generally flat tabletop surface 130 extending parallel to a flat top surface 132 of the lower part 104. The flat top surface 132 of the lower part 104 is spaced apart and separated from the tabletop surface 130 so that two supporting levels 140, 142 are created for supporting different objects at different vertical levels relative to ground. The two supporting levels 140, 142 are coupled to each other via legs 106. Legs 106 extend from a bottom side of the top supporting level 140 towards the bottom supporting level 142. The legs 106 pass through apertures 144 formed in the lower part 104. The legs 106 and apertures 144 are designed to allow the bottom supporting level 142 to sliding move towards and/or away from the top supporting level 140.

Part of the table 100 may be described herein as being aligned with each other. The alignment of the parts may be in relation to an orientation when the parts are in a deployed or expanded configuration or when viewing the table from above. The alignment may also or alternatively be in relationship to a stowed or collapsed configuration when the upper part 102 is adjacent to and/or in contact with the lower part 104 and/or when the legs 106 are collapsed.

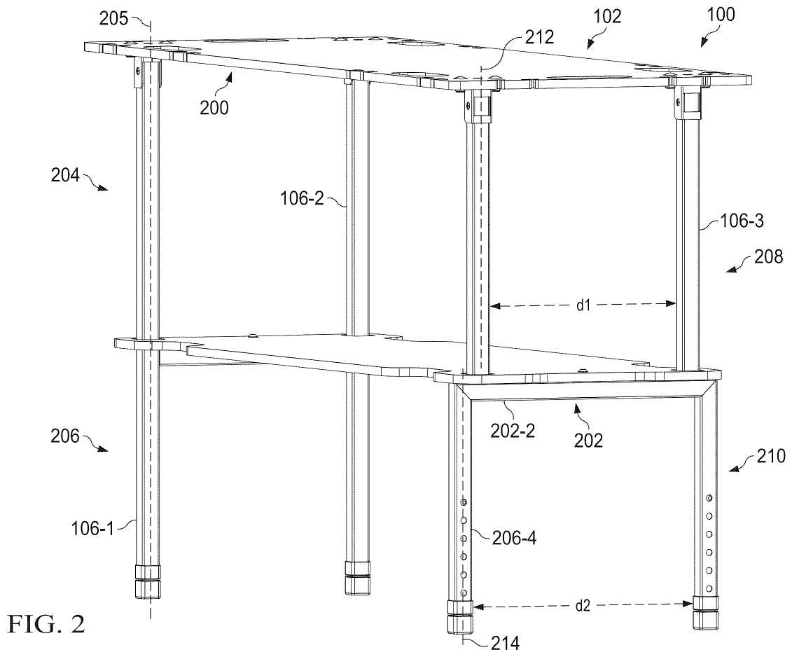

FIG. 2 provides an illustration in which the structure of the legs 106 is more visible. Legs 106 may occur in pairs and be coupled together. For example, legs 106-1 and 106-2 provide a first pair of legs, while legs 106-3 and 106-4 provide a second pair of legs. Each pair of legs is attached to a bottom surface 200 of the upper part 102. This coupling can be achieved via mechanical couplers. The mechanical couplers can include, but are not limited to, brackets, screws, nuts, and adhesives.

Each leg 106-1 and 106-2 has a first straight portion 204 and a second straight portion 206. The first and second portions 204, 206 have center axes 208 that are aligned with each other as shown in FIG. 2.

Each leg 106-3 and 106-4 also has a first straight portion 408 and a second straight portion 210. The first and second portions 208, 210 of each leg have center axes 212, 214 that are offset from each other as shown in FIG. 2. As such, the distance dl between top portions of legs 106-3 and 106-4 is less than the distance d2 between bottom portions of legs 106-3 and 106-4.

The legs of each pair are coupled to each other via a cross bar 202. For example, legs 106-1 and 106-2 provide a first pair that are coupled to each other via cross bar 202-1, while legs 106-3 and 106-4 of the second pair are coupled to each other via cross bar 202-2. Each cross bar extends between the two legs of the respective pair. The top portion 208 of each leg 106-3, 106-4 is coupled to the cross bar 202-2 at a different location than the location along the cross bar at which the bottom portion 210 is coupled.

The cross bars 202 may be configured to structurally support the lower part 104 when the table 100 is in its deployed or expanded configuration shown in FIG. 2. The cross bars 202 are located at a location along the legs to maintain the lower part 104 a certain distance from the upper part 102 when they are being used to structurally support the lower part 104. The cross bars 202 may also be configured to act as a stop for the sliding movement or translation of the lower part 104 away from the upper part 102.

When the table 100 is in the deployed or expanded configuration, the upper part 102 is separated from the lower part 104 and the legs 106 are perpendicular to the upper and lower parts. The lower part 104 may be resting on a cross bars 402 of the leg pairs.

One or more locks maybe provided to secure the lower part 104 to the cross bar(s). The lock(s) may (i) prevent the lower part 104 from sliding along the legs 106 towards the upper part 102 when the table is turned upside down, and/or (ii) prevent the lower part 104 from unintentionally sliding along the legs 106 and/or contacting the upper part 102 and potentially pitching figures or otherwise hurting user(s). The lock(s) can include any known or to be known lock mechanism. The lock mechanical can include, but is not limited to, a protrusion, a button, a hook, and/or a roughened surface. In the button scenario, the button may extend out of the leg 106 above a top side of the lower part 104 that creates a structure preventing the lower part 104 from moving past a certain point along the legs. The button may be spring loaded so that when pushed by a user it at least partially moves into the leg 106. In this way, the button can be actuated to selectively prevent the lower part 104 from sliding towards the upper part 102 and/or selectively allow the lower part 104 to slide further towards the upper part 102. The present solution is not limited to the particulars of this example.

A pin may extend from the cross bar 202 of at least one pair of legs. The pin may provide a frictional engagement with an indentation on the lower part 104 so that the user can push the lower part 104 towards the upper part 102 to disengage the lower part 104 from the pin, whereby the lower part 104 can be moved towards the upper part 102. The lower part 104 may also include a shaped aperture. In this scenario, the pin includes a top portion having a shape corresponding to the shape of the aperture. The pin may rotate or otherwise be manipulated to align the pin with the aperture and permit the pin to pass by and through the aperture. The pin may also rotate or otherwise be manipulated to misalign the pin with the aperture such that the edge of the aperture of the lower surface contacts and engages the shape of the upper part 102 of the pin and prevents the upper part 102 from passing past the pin.

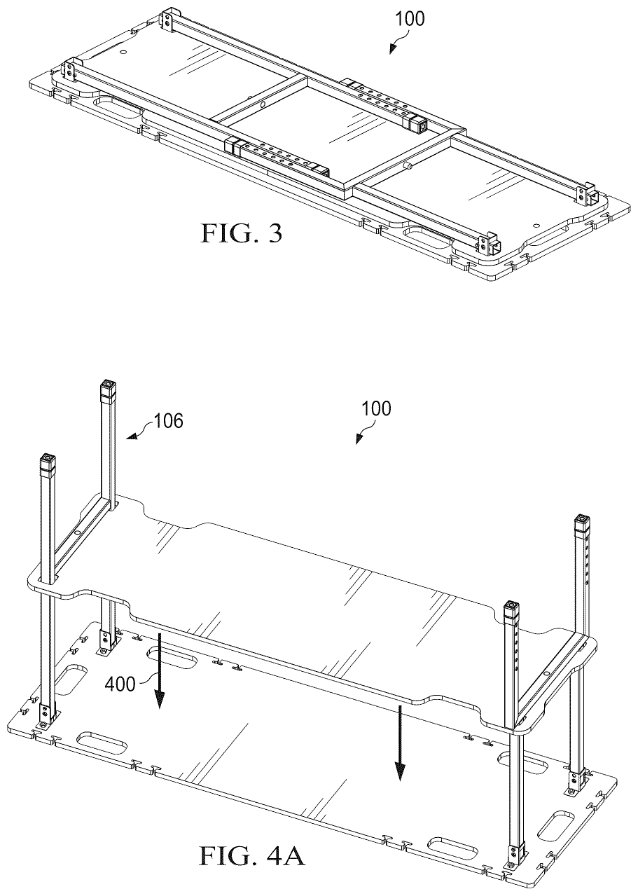

FIG. 3 provides a bottom view of the able 100 in the stowed or collapsed configuration. In the stowed or collapsed configuration, the lower part 104 is parallel and adjacent to and/or in contact with upper part 102. The legs 106 are parallel to the upper and lower parts 102, 104. The legs 106 may be in contact or adjacent to the lower part 104. The legs 106 may be rotated generally perpendicularly from the orientation of the legs 106 in the expanded configuration.

The lower part 104 may have the same or similar shape as that of the top surface such that they appear to at least partially or fully overlap each other when viewed from above or below. In some scenarios, the lower part 104 may be smaller than the upper part 102. The difference in size may permit the upper part 102 to define an overhang or flanged edge with respect to the lower part 104 when the lower part 104 is positioned next to and/or in contact with the upper part 102. In FIG. 3, the lower part 104 is smaller than the upper part 102 such that the upper part 102 overhangs the entire perimeter of the lower part 104. The present solution is not limited in this regard.

As seen in FIG. 3, the legs 106 may fold together under the lower part 104 when the lower part 104 is positioned adjacent the upper part 102. In the folded position, the legs 106-1, 106-2 overlap vertically with legs 106-3, 106-4. However, legs 106-1, 106-2 may or may not be in contact with legs 106-3, 106-4.

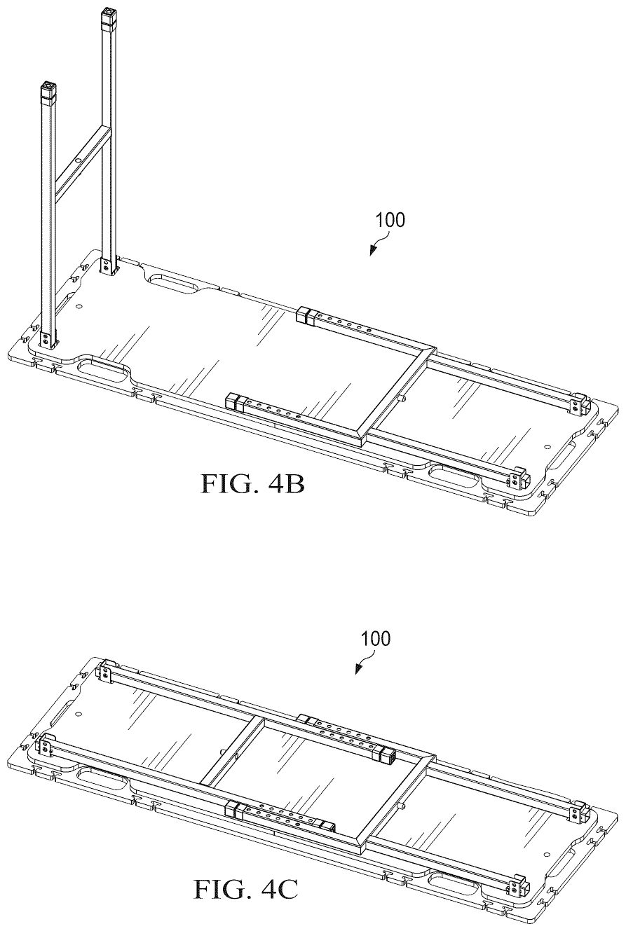

FIGS. 4A-4C (which may collectively be referred to as FIG. 4) provide illustrations that are useful for understanding how table 100 transitions from a deployed or expanded configuration to a stowed or collapsed configuration. First, the lower part 104 is moved toward the upper part 102 as shown by arrows 400 in FIG. 4A. A lock may be unlocked to allow movement of the lower part 104. Once unlocked, the lower part 104 may then be slid along the legs 106 toward the upper part 102. If the table 100 is upside down, gravity may be used to facilitate movement of the lower part 104 towards the upper part 102.

Next, a set of legs are transitioned from their unfolded positions to their folded positions. To fold the legs, a pushing force can be applied to their free ends towards the center of the table 100. The pushing force causes the legs to rotate inward towards the upper part 102. The rotations can be facilitated by hinges coupled between the upper part 102 and the leg. The hinges may be configured such that the legs need to be pulled away from the upper part 102 to allow for such rotations. Rotation of the legs is discontinued when the legs reach the folded position shown in FIG. 4B. Once the set of legs is in its folded position, the other set of legs are caused to rotate towards the center of the table 100 as shown in FIG. 4C.

In some scenarios, legs 106-1, 106-2, 106-3 and/or 106-4 may be telescoping such that the second straight portion(s) 206, 210 can be actuated to collapse into the first straight portion(s) 204, 208, whereby the overall length of one or more legs is shortened. This telescoping can be performed prior to the rotation of the legs.

This process can be reversed to transition the legs back to their unfolded positions. For example, the legs may be rotated in an opposite direction so that the second straight portion(s) 206, 210 thereof are moved away from the upper part 102. The legs may then be extended if they are telescoping or shorted in another manner. Once perpendicular to the upper part 102, the legs may be pushed toward the upper part 102 to disengage rotation of the hinge and/or to lock the legs in the unfolded position. The table may be turned over and the lower part 104 moved away from the upper part 102. The lower part 104 may be rested on the cross bars of the legs. The lower surface may be locked in place. The table may thereafter be used, for example, by coupling accessories thereto. The accessories can include, but are not limited to, tools, tool holders, cup holders, etc.

The legs are described herein as being translated relative to the upper part 102 before rotation occurs. The translation or offsetting of the hinge to permit rotation may be in either of orthogonal directions. For example, as previously described, the legs from the unfolded position are pulled away from the upper part 102 and then rotated toward the upper part 102. The legs from the collapsed position may also be pulled along the upper part 102 (or parallel to the upper part 102), before the leg can be rotated away from the upper part 102. Either or both configurations of the hinge may be used in as described herein.

FIGS. 5A-5F (which may collectively be referred to as FIG. 5) provide illustrations showing close-up views of certain features of the table 100. These features may be used in any combination, including being added, removed, duplicated, or relocated and remain within the scope of the present disclosure.

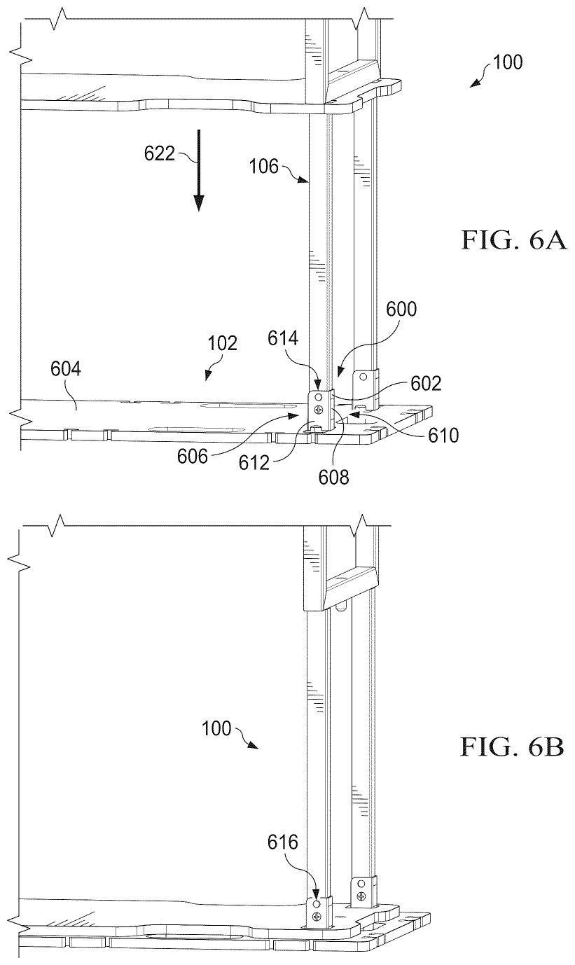

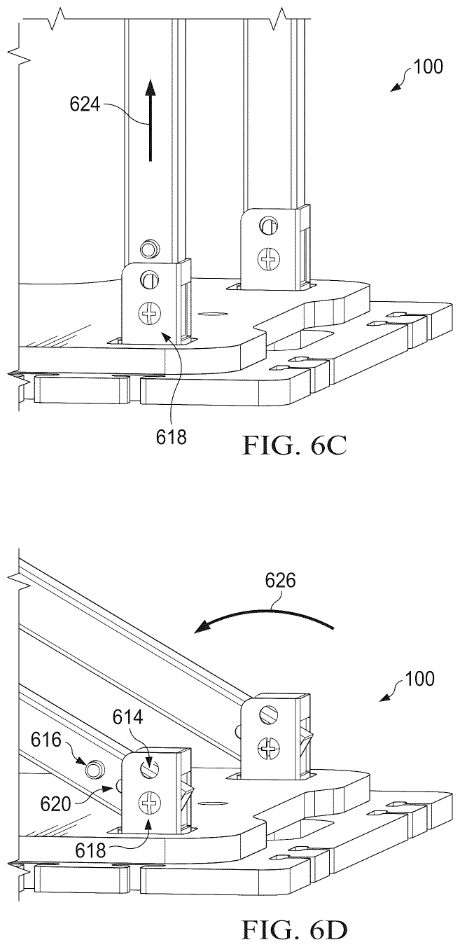

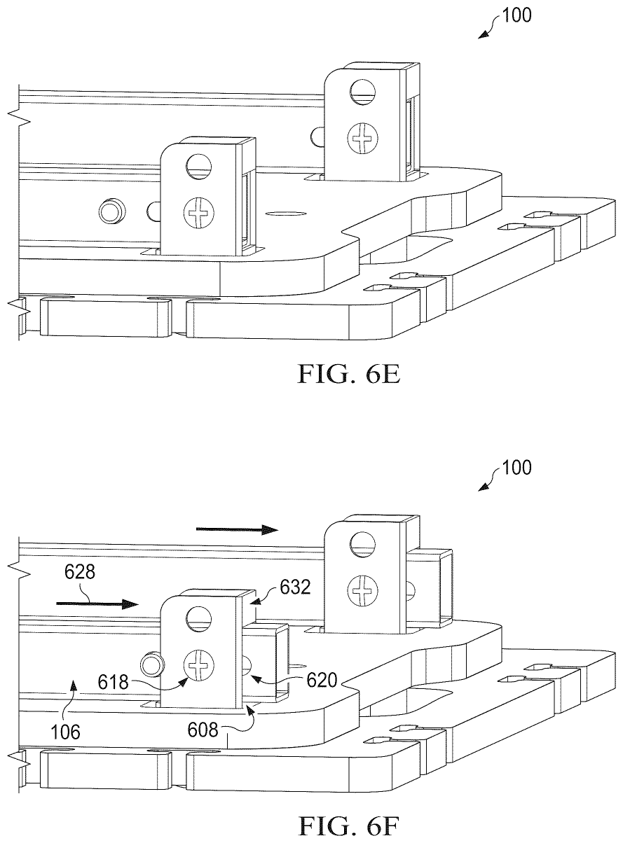

FIGS. 6A-6F (which may collectively be referred to as FIG. 6) provide illustrations that are useful for understanding how the table 100 transition from the deployed or expanded configuration to the stowed or collapsed configuration. These illustrations are particularly focused on the legs 160 and operation of the locking mechanisms associated therewith. A coupler 600 is provided with each leg.

The coupler can include, but is not limited to, a collar 602 coupled to the bottom side 604 of the upper part 102. The collar 602 has an inside shape approximating an outside shape of the top end of the leg 106. As illustrated, the collar 602 has a generally square-shaped cross-sectional profile. A sidewall may not be provided on one side 606 of the collar. The collar 602 has an opening 608 on the side 610 which is opposed from side 606. Sidewalls 612 are provided on the other two sides of the collar which extend from the bottom side 604 of the upper part 102 a certain distance. An aperture 614 is provided in at least one of the sidewalls 612. The aperture 614 is sized and shaped to slidingly receive a depressible member such as a resiliently biased button (not shown) or spring clip 616. The spring clip 616 can be used to selectively lock and unlock the leg 106 in its unfolded position.

A shaft 618 is coupled between the two sidewall 612. The shaft 618 is sized and shaped to fit in an elongated slot 620 formed in the leg 106. If the leg 106 is hollow, then the elongated slot 620 would be provided through two opposing sidewalls of the leg so that the leg can slidingly receive the shaft therein. This shaft/slot arrangement allows the leg 106 to be moved in direction 624 and at least partially out of the collar 602, as shown in FIG. 6C.

As shown in FIG. 6D, the leg 106 can then be rotated about shaft 618 of the collar 602. The open side 606 of the collar allows the leg 106 to further rotate in a direction 626 until it reaches its folded position shown in FIG. 6E. At this time, the leg 106 can be pushed in direction 628 as shown in FIG. 6F such that a portion of the leg travels through opening 608 formed on side 610 of collar 602. The shaft 618 slides within the elongated slot 620 of the leg 106 while the leg travels in direction 628. The leg 106 is prevented from moving further in direction 628 when the shaft 618 contacts a sidewall of the elongated slot 620. The leg 106 is prevented from rotating relative to the collar by sidewall 610 of the collar. A lock may be provided to lock the leg in this position.

This process can be reversed to transition the leg 106 from the folded position to the unfolded position. For example, the leg may be pulled in a direction opposite to direction 628 out of opening 608, and then rotated in a direction opposite to direction 626 until it is perpendicular with the upper part 102 of the table 100. The spring clip 616 can be pressed to transition it from an uncompressed state to a compressed state. At which time, the leg 106 can be pushed in a direction 622 until the spring clip 616 becomes aligned with aperture 614. When this alignment occurs, spring clip 616 can automatically transition from a compressed state to an uncompressed state, whereby it at least partially extends through the aperture 614 to once again lock the leg 106 in its unfolded position.

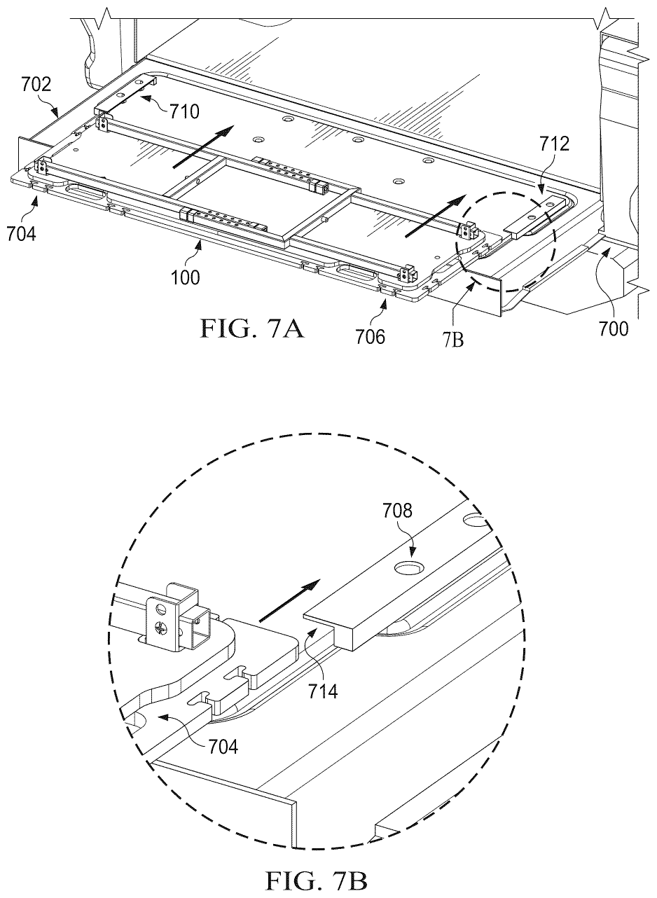

FIGS. 7A-7B (which may collectively be referred to as FIG. 7) provide illustrations that are useful for understanding how the table 100 can be stowed in a tailgate 702 of a truck 700. The table 100 in the collapsed configuration may include a flange on each short side 704, 706. A bracket 708 can be provided on each short side 710, 712 of the tailgate 702. The bracket 708 is configured to provide a slot 714 in which the table's flange 704 can be slidingly received. The flange and bracket arrangement may permit the interior portion of the table 100 to be larger than the thickness than that of the perimeter edge portion of the table. A stop structure (not visible in FIG. 7) can be provided with the bracket 708 to limit the distance that the table's flange 704 can travel in the slot 714. The present solution is not limited to the particulars of FIG. 7. In other scenarios, the bracket 708 is sized and shaped to receive two or more table's flange 704, whereby multiple tables can be stowed on the tailgate 702 of a truck 700.

Exemplary embodiments of the table described herein may include other features such as rubber or friction leg ends to reduce slipping. The leg ends may also or alternatively be contoured. The legs may also be telescoping and may permit variable length or changing the overall height of the table's top surface and/or lower surface. The telescoping legs may change a height of the length at different portions of the leg, such as between the table's top surface and the lower surface or below the lower surface to the ground. The telescoping legs may permit one or more different lengths of the legs to be chosen. The telescoping legs may use two leg portions that are configured to slide along each other, such as with one inside the other. On of the two portions of a leg may include a spring-loaded pin to engage one or more holes in the other of the two portions of the leg.

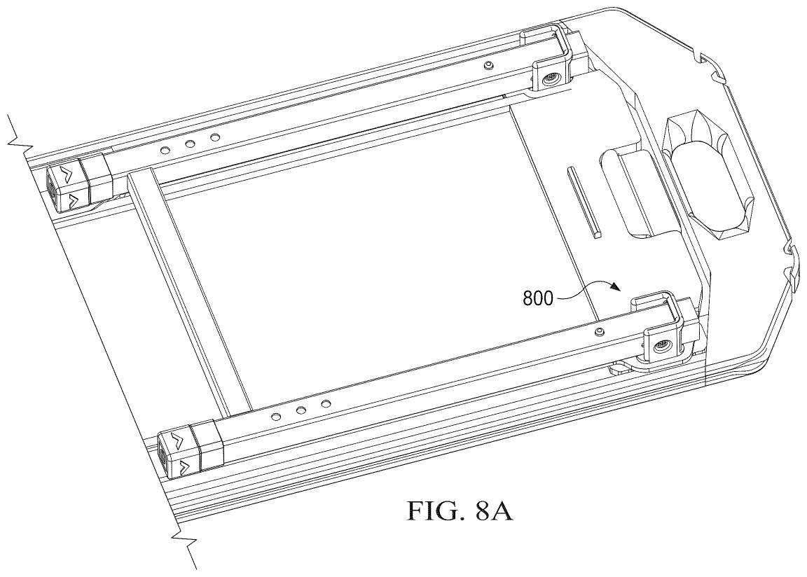

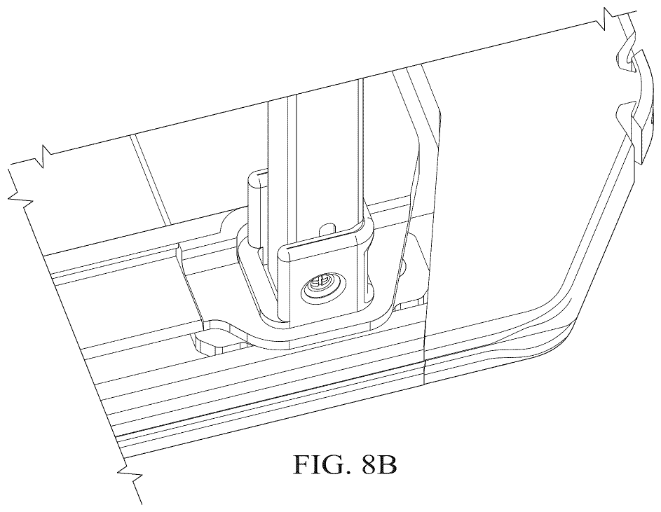

FIGS. 8A-8B (which may collectively be referred to as FIG. 8) provide illustrations that are useful for understanding a hinged connection between legs and an upper part of the table. A hinge 800 may be provided instead of the collar 602 described above in relation to FIG. 6. Hinges are well known. Any known or to be known hinge can be used here.

The hinge 800 comprises a body portion and an extension. The extension is configured as an elongate body. A first terminal end of the elongate body may be configured to mate with the body portion as described herein. The second terminal end of the elongate body may be any configuration, and need not even remain elongated, linear, etc. the first terminal end of the elongate body may have a cylindrical configuration of constant cross-sectional shape. The cross-sectional shape is illustrated as rectangular or square, but other cross-sectional shapes are contemplated herein, including without limitation a circular or ovoid shape.

The body portion comprises a wall. In an exemplary embodiment, the wall fully circumscribes a perimeter of the body portion. The wall may define an inner cross-sectional shape approximate to the outer cross-sectional shape of the extension. As illustrated, the wall defines an inner cavity having a cross-sectional shape of a rectangle or square. Other shapes are contemplated herein. For example, circular or ovoid shapes are also contemplated herein. As would be apparent from a person of skill in the art, the circular or ovoid shape may be used like a clamp so that the extension may be pushed into an opening of the ovoid or circular wall shape and be retained therein if the wall extends more than 180 degrees about the extension.

The wall is described herein in terms of sides. The sides of the wall is exemplary only and does not restrict the configuration of the wall to the square cross-sectional shape as illustrated. Instead, the sides are intended to refer to orthogonal directions of a component part so that one side is distinguished from a second side and positioned opposite to the first side, while the third and fourth sides are positioned orthogonal to the first and second sides and opposite to each other. For example, the cross-sectional shape of the extension may be square, and each side is the side of the square. As another example, the cross-sectional shape of the extension may be circular, and each side is an orthogonal apex and associated curved edge for ¼ of the component part, similar to the alignment of the component part along an artesian coordinate system.

In an exemplary embodiment, the body comprises a wall that fully circumscribes a perimeter, and defines an enclosure. The enclosure, defined by the wall, may have one open end or may be open at both ends. As illustrated in FIG. 8A, the wall has a first terminal edge. As illustrated, the first terminal edge is positioned adjacent or next to the underside of the first surface or the lower side of the tabletop. The first terminal edge may be generally planar to match the contour of the table. The first terminal edge may have other shapes corresponding to the surface to which the hinge may be coupled. The first terminal edge may include a flanged lip such as for attaching the body to another surface, such as the underside of the tabletop in the exemplary application. As illustrated, the wall fully circumscribes a perimeter at the first terminal edge of the wall. In an exemplary embodiment, the wall at and/or proximate to the first terminal edge is configured for the first terminal end of the elongate body of the extension may be positioned therein and fully enclosed about a perimeter of the elongate body by the wall.

The wall may extend to different lengths from the first terminal end to a second terminal end along a length of the body. The wall may have openings therein.

A first opening is at a second terminal edge of the wall. The opening is therefore defined by the terminal end of the wall having a shorter length than the wall on adjacent sides of the opening. For example, a first opening may be in a first side of the wall and third and fourth sides of the wall positioned on opposite sides of the first side extend upward past the terminal end of the first side. The first opening therefore may have a wall on three sides thereof. The first opening may not be fully enclosed but may be in communication with an open end of the wall. As illustrated, the third and fourth sides of the wall are contoured or curved so that the opening in the first wall is defined by the tapering of the third and fourth walls toward the first terminal edge of the wall and then extending across between the third and fourth walls at the first terminal edge across the first side of the wall. The first opening may be shaped so that at least a portion of an edge of the first opening approximates an outer cross-sectional shape of at least a portion of the first terminal end of the elongate body. The first opening may be sized and shaped so that the elongate body may be positioned therethrough in a collapsed configuration and be enclosed on at least two sides by the third and fourth sides of the wall.

As illustrated, the wall comprises an opening on a second side of the wall, opposite the first side of the wall. The second opening may be between the first terminal edge and the second terminal edge of the second wall so that the opening is enclosed by the second wall on opposite sides and on the other two sides by the third and fourth sides of the wall. The second opening is therefore fully enclosed by portions of the wall. The cross-sectional shape of the second opening may approximate the outer cross-sectional shape of the first terminal end of the elongate body. The second opening may be sized and shaped so that the elongate body may be positioned therethrough in the collapsed configuration and be enclosed on at least two sides by the third and fourth sides of the wall.

In an exemplary embodiment, the second opening is configured to overlap the first opening. The overlapping of the second opening with the first opening is configured to permit the first terminal end of the elongate body of the extension to be positioned through the first opening and the second opening simultaneously in the collapsed configuration.

In an exemplary embodiment, a hinge comprises a body. The body comprises a first wall on a first side of the body, and a second wall on a second side of the body. The first and second walls may be generally parallel. The first and second walls may have approximately the same shape. The first and second walls may have third wall extending on one edge of the first and second walls coupling the first and second walls together. The third wall may have a length that is length than a length of at least the first and/or second wall. The first and second walls may have a fourth wall extending on a second edge of the first and second walls coupled the first and second walls together. The third and fourth walls may be on opposite edges of the first and second walls. The first, second, third, and fourth walls may define an enclosed perimeter defining an interior cavity. The interior cavity may be at a first end region of the first and second walls. The interior cavity may be configured such that a terminal end of an elongated portion of a member may be inserted and/or retained therein. The interior perimeter of the interior cavity may have an approximate size and/or shape as an outer perimeter of a cross section of the member. The first and second walls may be coupled together by a fifth wall parallel to the fourth wall. The fifth wall may extend on the second edge of the first and second walls so that the fourth and fifth walls are on the same side of the first and second walls as each other. The fourth and fifth wall may be separated from each other such that a gap is created therein. The gap may define an opening. The opening may be configured such that a terminal end of an elongated portion of a member may be inserted therethrough and a portion of the elongated portion of a member be positioned therein. The opening may have an approximate size and/or shape as an outer perimeter of a cross section of the member.

In an exemplary embodiment, the body has an axle (such as a pin, rod, etc.) extending from a first side thereof to a second side thereof, opposite the first side. According to the embodiments described herein, the axle may extend between the first and second side of a wall or between a first wall and a second wall. The member described herein may have a hole therethrough such that the axle may extend through the hole and the member be rotatable about the axle. In an exemplary embodiment, the hole is elongated so that the member can translate along the axle and/or rotate about the axle. As illustrated, the pin comprises a screw that extends across the housing from a first side to a second side thereof.

As illustrated, the member may have a locking features. The body may have one or more mating features that are configured to accept or interface with the locking feature so that the member may be locked in position relative to the body when the locking feature is engaged with the mating feature. As illustrated, the locking feature is a spring pin that is biased outward and the mating feature is an aperture in the body. The spring pin may be compressed so that it fits within the body. The member may be moved so that the pin is aligned with the aperture and the pin extends outward through the aperture. The member may then be locked relative to the body as the pin prevents rotational and/or translational movement of the member to the body. As illustrated, the body comprises two mating features so that the member may be locked in the collapsed configuration and in the extended configuration.

The enclosures described herein are in terms of fully enclosed, fully circumscribed, full perimeter, etc. The embodiments described herein also include substantially enclosed, circumscribed, or substantially full perimeters, etc. Substantial as used herein may include breaks, openings, etc. but for which enough of the enclosure is retained to achieved the purposes described herein. The application of the hinge and/or table in combination with the knowledge of a person of skill in the art would appreciate what is sufficient in order for the wall to be substantially enclosed. In an exemplary embodiment, substantial means more than 50%, more than 75%, or more than 90%, and may depend on whether the term substantial is used to describe a side, wall, portions, or a complete component or perimeter enclosure.

FIGS. 8A-8B illustrate the different configurations of the body and member as the member is positioned and transitioned between the collapsed configuration and the expanded configuration.

As illustrated in FIG. 8A, the member is positioned in a first position relative to the housing. The locking feature of the member is engaged with a first mating feature of the housing. The member extends through an opening in the housing. The housing therefore fully circumscribes or substantially circumscribes the member about an exterior perimeter thereof. The locking feature of the member is a spring-biased pin positioned in a first aperture of the housing.

As illustrated in FIG. 8B, the locking feature of the member may be disengaged from the mating feature of the housing so that the member is configured to translate relative to the housing. The member may be moved out of the opening of the housing. The locking feature may be disengaged. As illustrated, the spring-biased pin is outside of the housing.

The member can be configured to rotate relative to the housing. The wall(s) of the housing may be shaped so that the wall does not interfere with the locking features. The first side and second side of the wall or the first and second walls are curved so that the spring-biased pin extending outward does not encounter the wall or interfere with the rotational movement of the member relative to the housing.

The member may be oriented perpendicularly to the original orientation of the member. The locking feature may be disengaged so that the member may translate relative to the housing. The spring-biased pin may be depressed so that that the pin may fit within the housing and the member translate into the housing. The locking feature may thereafter engage with a second mating feature of the housing. The spring-biased pin can extend outward through a second aperture within the housing.

The member may be positioned within the housing so that a substantial portion of the housing circumscribes the member. The member may be positioned within the enclosure defined by the wall(s) of the housing.

Exemplary embodiments of the hinge described herein may provide one or more advantages. As illustrated, the wall of the housing may provide a separation from a lower surface of the housing so that a gap is created thereby. The gap may be used to position another surface or structure. The member may therefore be in a collapsed configuration while provided space to accommodate other components parts, such as the lower surface described herein. As illustrated, the substantial enclosure of the member in one or more configurations may provide added strength and/or stability to the member when in that position. The member may therefore be supported without the use of additional cross members. The resulting structure may be more robust, sturdy, and/or hold additional weight. As illustrated, the member may be supported on all fours sides of the member in one and/or two positions of the member relative to the housing. As illustrated, the locking features may be used to require positive action by a user to transition the member relative to the housing.

A wall accessory can be used with table 100. Such a wall accessory may be configured to mount to the table 100 and/or to a wall. The wall accessory may include a panel that has apertures that are the same as or approximate the apertures 120 on the table 100. In this regard, apertures are generally T-shaped. Any number of apertures can be provided with the wall accessory. The apertures may be equally or unequally spaced apart from each other in accordance with a given application. The wall accessory can be used to structurally support tools or other items. For example, a worker may use the wall accessory to support and/or organize tools or other items. The wall accessory can then be removed from the wall and positioned on the upper part 102 of the table such that the apertures are aligned with apertures 120 on the table 100. The user may therefore move accessories from a storage location to a work location without having to reorganize the accessories. Other accessories are contemplated hereby.

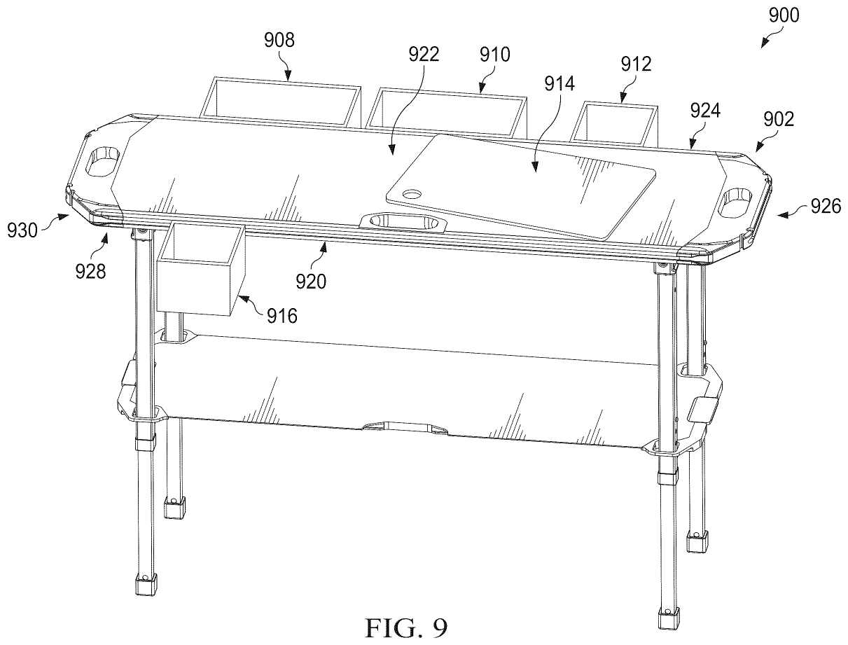

With reference to FIG. 9, there is provided an illustration of a table assembly 900 comprising a table 902 and accessories 904, 906, 908, 910, 912, 914, 916, 918. The accessories 904-918 are shown coupled to the table 900 in FIG. 9. The table 900 is similar to table 100 but with some differences, for example, relating to the legs and the manner in which accessories can be coupled thereto and decoupled therefrom. In addition to or as an alternative to aperture(s) 108, 120-126 of FIG. 1, table 900 employs one or more tracks (or railings) 920. The tracks 920 can be attached to the sidewalls of the table via any attachments means (e.g., screws, adhesives, etc.). Alternatively, the tracks 920 can be integrally formed with the sidewalls of the table, for example, during an injection moulding process.

A track can be provided on one or more sidewalls 924, 926, 928, 930 of the upper part 922 of the table 900. Each track 920 has a slot sized and shaped to receive at least a protruding portion of one or more accessories 904-918. The protruding portion may include, but is not limited to, a rolling wheel or post with an enlarged circular head. In this way, the accessory can be (i) slide in two opposing directions relative to a respective sidewall 924, 926, 928, 930 of the upper part 822 of the table 900, and (ii) suspended adjacent to the table 900 as shown in FIG. 9. The tracks may or may not comprise a stop member at one end thereof to prevent the accessory from sliding out of the track. The stop member may be fixed or removable. The stop member can be formed of any suitable material such as metal and/or rubber.

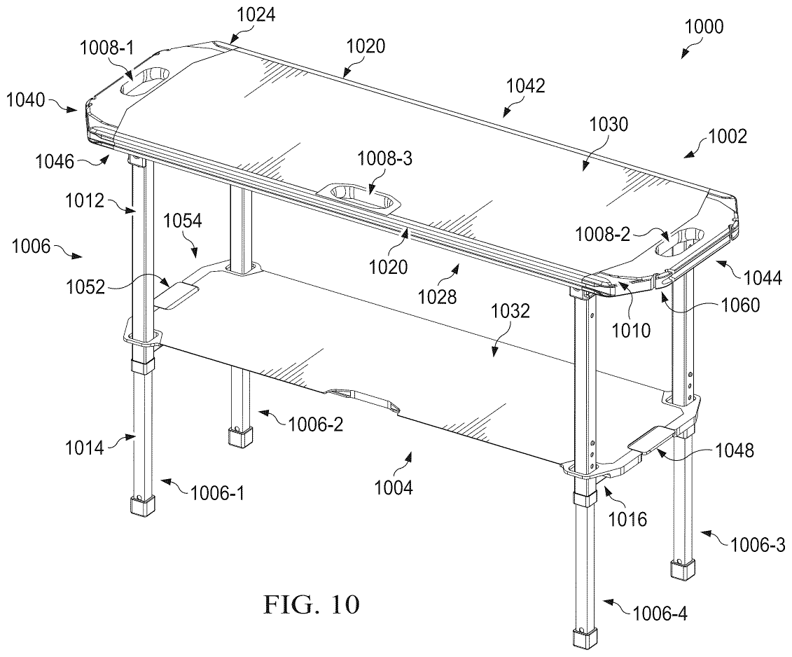

The table 900 will now be described in more detail in relation to FIG. 10 via a substantially similar embodiment of table 1000. Table 1000 has an upper part 1002, a lower part 1004, and four legs 1006. The legs 1006 (i) extend between the upper part 1002 and the lower part 1004, and (ii) extend past the lower part 1004 to support the upper and lower parts 1002, 1004 above the ground, floor or other object there below.

The lower part 1004 may be used to define a shelf of the table 1000. The lower part 1004 may be separated from the table 1000. In this regard, protruding members 1048, 1052 are provided on the short sides 1050, 1054 of the lower part 1004. The protruding members 1048, 1052 may be used as handles for gripping and/or removing the lower part 1004 from the table 1000.

The upper part 1002 provides a tabletop for the table 1000. The upper part 1002 has aperture(s) 1008-1, 1008-2, 1008-3 (collectively referred to as “1008”) formed therethrough. The aperture(s) 1008 are located adjacent to an outer perimeter of the upper part 1002. Each aperture 1008-1, 1008-2, 1008-3 may comprise an elongated hole with a longer dimension aligned with a respective edge 1040, 1042, 1044, 1046 of the table 1000 to which the aperture is adjacent. The aperture 1008-1, 1008-2, 1008-3 may provide handles for gripping and/or moving the table 1000. Although three apertures 1008 are shown, any number thereof can be provided in accordance with a given application.

The apertures 1008-1, 1008-2, 1008-3 (collectively 1008) are shown as having a curved rectangular or ovoid shape. The present solution is not limited in this regard. The apertures 1008 may have other shapes such as a rectangular shape and a square shape. The apertures 1008 may be fully enclosed by the material of the upper part 1002 as shown, or alternatively only be partially enclosed by the material of the upper part 1002 (not shown). For example, each aperture 1008-1, 1008-2, 1008-3 may alternatively comprise a “T” opening from the perimeter edge of the table, or some other shape or configuration.

Other apertures (not shown for ease of illustration) may be provided on the upper part 1002, as shown in FIG. 10. The apertures may be configured to assist with carrying the table 1000, securing the table 1000 in a stowed or collapsed configuration, and/or provide accessory couplers. For example, apertures may be used as attachment points for accessories and other objects. In this way accessories and other objects can be removably attached to the table 1000 via hooks, hangers and/or other mechanical couplers. These apertures may comprise different shapes. One or more of the apertures may provide a bottle opener or hook. Referring to FIG. 9, the accessories can include, but are not limited to, a drying rack 914, storage bin(s) 908, 910, 912, 916, 918, a cutting board 914, and/or a paper towel holder 906 with a hanging hook at its free end.

Apertures may have generally L-shapes. The present solution is not limited in this regard. The apertures can have other shapes selected in accordance with a given application. For example, one or more apertures can alternatively have a T-shape or Y-shape. Any number of apertures can be provided in accordance with a given application.

Referring to FIGS. 9 and 10, one or more tracks 1020 are provided on the two long sides 1024, 1028 of the table 1000. Each track 1020 has a slot 1010 sized and shaped to receive at least a protruding portion of one or more accessories 904-918. The protruding portion may include, but is not limited to, a rolling wheel or post with an enlarged circular head. In this way, the accessory can be (i) slide in two opposing directions relative to a respective sidewall 924, 926, 928, 930 of the upper part 922 of the table 900, and (ii) suspended adjacent to the table 900 as shown in FIG. 9. The tracks may or may not comprise a stop member at one end thereof to prevent the accessory from sliding out of the track. The stop member may be fixed or removable. The stop member can be formed of any suitable material such as metal and/or rubber.

The lower part 1004 may be used to define a shelf or second layer of the table 1000. The lower part 1004 may be separated from the upper part 1002 to define two separate supporting structures for the table 1000. Protruding members 1048, 1052 may be provided on the short sides 1050, 1054 of the lower part 1004. The protruding members 1048, 1052 may be used as handles for gripping and/or removing the lower part 1004 from the table 1000..

In FIG. 10, the table 1000 is shown in the deployed or expanded configuration with the upper part 1002 providing a generally flat tabletop surface 1030 extending parallel to a flat top surface 1032 of the lower part 1004. The flat top surface 1032 of the lower part 1004 is spaced apart and separated from the tabletop surface 1030 so that two supporting levels are created for supporting different objects at different vertical heights relative to ground.

The upper part 1002 is securely coupled to legs 1006. Legs 1006 extend out and away from a bottom side of the upper part 1002. Each leg 1006 is a telescoping leg comprising a first tube portion 1012 and a second tube portion 1014. The first tube portion 1012 is hollow with an inner channel having a size larger than the size of the second tube portion 1014. The second tube portion 1014 can be slidingly received in the inner channel of the first tube portion 1012. The second tube portion 1014 can slide into and out of the first tube portion 1012.

The first tube portions 1012 of two adjacent legs 1006 are connected to each other via a cross bar 1016. The cross bar 1016 may be configured to structurally support the lower part 1004 when the table 1000 is in its deployed or expanded configuration shown in FIG. 10. The cross bars 1016 are located at a location along the legs to maintain the lower part 1004 a certain distance below the upper part 1002 when they are being used to structurally support the lower part 1004.

The telescoping legs facilitate a transition of the table 1000 from the deployed or expanded configuration to a stowed or collapsed configuration (and vice versa). To transition the table to the stowed or collapsed configuration, the lower part 1504 is first removed from the table 1000. Next, the second tube portions 1014 of the four legs 1006 are slid into the first tube portions 1012 thereof. This results in a decrease in overall length of the four legs 1006. The collapsed legs 1006 are then rotated towards a center of the table 1000 until they reside adjacent to the bottom surface of the upper part 1002. Any mechanical coupling can be used to couple the legs 1006 to the upper part 1002 provided that they allow rotation thereof. This process can be reversed to transition the table 1000 to the deployed or expanded configuration. It should be noted that the length of the first tube portions 1012 of each leg is less than half the length of the upper part 1002 such that, during the transitions, its free end 1004 does not contact the free end 1006 of an opposing leg or such that its free end 1004 is able to slide against free 1006.

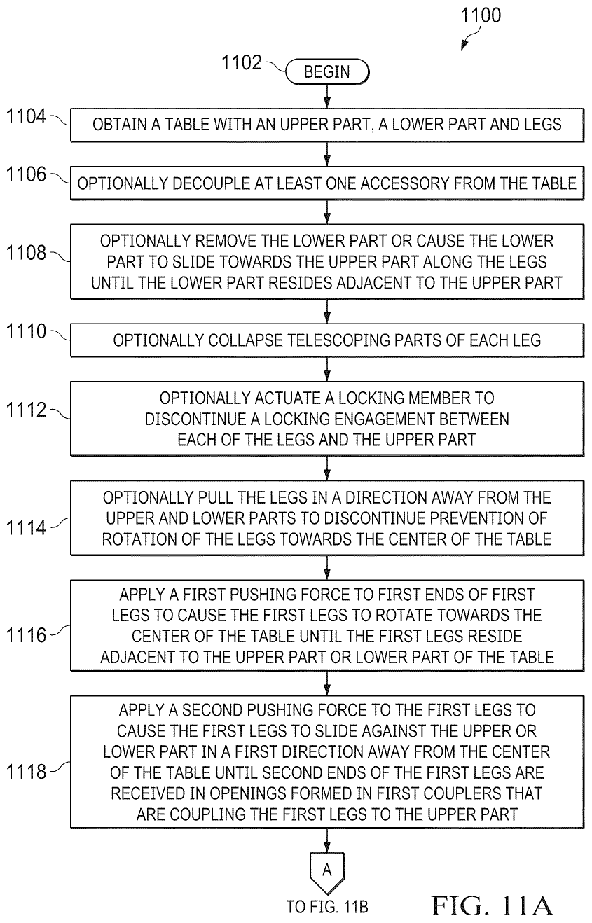

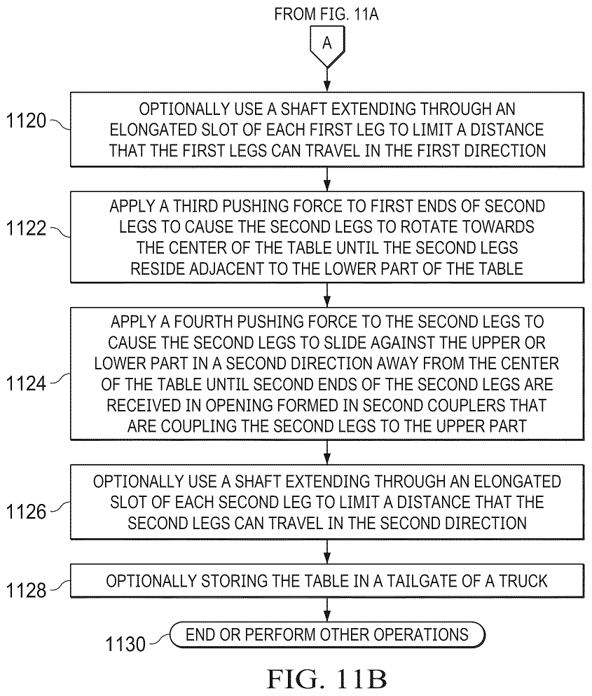

Referring now to FIG. 11A, there is provided a flow diagram of an illustrative method 1100 for operating a table (e.g., table 100 of FIG. 1 or 900 of FIG. 9). Method 1100 begins with 1102 and continues with 1104 where the table is obtained. The table comprises an upper part (e.g., upper part 102 of FIG. 1 or 1002 of FIG. 10), a lower part (e.g., lower part 104 of FIG. 1 or 1004 of FIG. 10), and legs (e.g., legs 106 of FIG. 1 or 1006 of FIG. 10).

In block 1106, at least one accessory (e.g., 904-918 of FIG. 9) is decoupled from the table. This decoupling may be achieved by sliding a protruding structure of the accessory through a channel (e.g., channel 1010) of a track (e.g., track 920) coupled to or integrated with a sidewall (e.g., sidewall 924, 926, 928 or 930 of FIG. 9) of the upper part. The protruding structure may have a moveable part (e.g., a rollable wheel) configured to facilitate ease with coupling and decoupling the accessory to/from the table. Additionally or alternatively, the protruding structure can have a coating to minimize friction between itself and the walls of the track's channel.

Method 1100 may continue to optional block 1108 wherein the lower part is removed from the table or caused to slide towards the upper part along the legs until the lower part resides adjacent to the upper part. A locking member may be actuated in block 1108 to allow for movement of the lower part relative to the upper part. Telescoping parts of each leg may optionally be collapsed in optional block 1110. A locking mechanism may be actuated in optional block 1112 to discontinue a locking engagement between each of the legs and the upper part. In block 1114, the legs are optionally pulled in a direction away from the upper and lower parts to discontinue prevention of rotation of the legs towards the center of the table.

Next in 1116, a first pushing force is applied to first ends of first legs (e.g., legs 106-3, 106-4 of FIG. 2 or 1006-3, 1006-4 of FIG. 10) which are coupled to each other by a first cross bar (e.g., cross bar 402 of FIG. 2 or 1016 of FIG. 10). The first pushing force causes the first legs to rotate towards the center of the table until the first legs reside adjacent to the upper part or lower part of the table. In 1118, a second pushing force is applied to the first legs to cause the first legs to slide against the upper or lower part in a first direction (e.g., direction 628 of FIG. 6) away from the center of the table until second ends of the first legs are received into openings (e.g., openings 608 of FIG. 6) formed in first couplers (e.g., 600 of FIG. 6) that are coupling the first legs to the upper part. Upon completing 1118, method 1100 continues to block 1120 of FIG. 11B.

As shown in FIG. 11B, block 1120 involves using a shaft (e.g., shaft 618 of FIG. 6) extending through an elongated slot (e.g., slot 620 of FIG. 6) of each first leg to limit a distance that the first legs can travel in the first direction (e.g., direction 628 of FIG. 6).

Next in block 1122, a third pushing force is applied to first ends of second legs (e.g., legs 106-1, 106-2 of FIG. 2 or 1006-1, 1006-2 of FIG. 10) which are coupled to each other by a second cross bar. The second pushing force causes the second legs to rotate towards the center of the table until the second legs reside adjacent to the upper or lower part of the table. The first ends of the second legs may horizontally and/or vertically overlap the first ends of the first legs when the first and second legs reside adjacent to the upper or lower part (e.g., as shown in FIG. 3). Additionally when the first and second legs reside adjacent to the upper or lower part, one or more of the following exist, (i) the first ends of the second legs may both be nested between first ends of the first legs, and/or (ii) the first ends of the second legs may extend parallel to the first ends of the second legs. The term “horizontally overlap” as used herein means to have common points on a horizontal axis, while the term “vertically overlap” as used herein means to have common points on the vertical axis. The horizontal axis and vertical axis extend perpendicular to each other. For example, the horizontal axis may comprise a y-axis and the vertical axis may comprise an x-axis. The present solution is not limited in this regard.

A fourth pushing force is applied to the second legs in block 1124 to cause the second legs to slide against the upper or lower part in a second direction away from the center of the table until second ends of the second legs are received into openings (e.g., openings 608 of FIG. 6) formed in second couplers (e.g., 600 of FIG. 6) that are coupling the second legs to the upper part. The second direction is opposite the first direction. Shaft(s) can be used in block 1126 to limit a distance that the second legs can travel in the second direction.

In optional 1128, the table is stored in a tailgate (e.g., tailgate 702 of FIG. 7) of a truck (e.g., truck 700 of FIG. 7). This can involve sliding at least right and left side portions (e.g., flanges 704 of FIG. 7) of the upper part into brackets (e.g., brackets 708 of FIG. 7) coupled to the tailgate when the table is in the stowed configuration. Subsequently, method 1100 continues to block 1130 where it ends or other operations are performed (e.g., the table is transitioned from its stowed configuration to its deployed configuration).

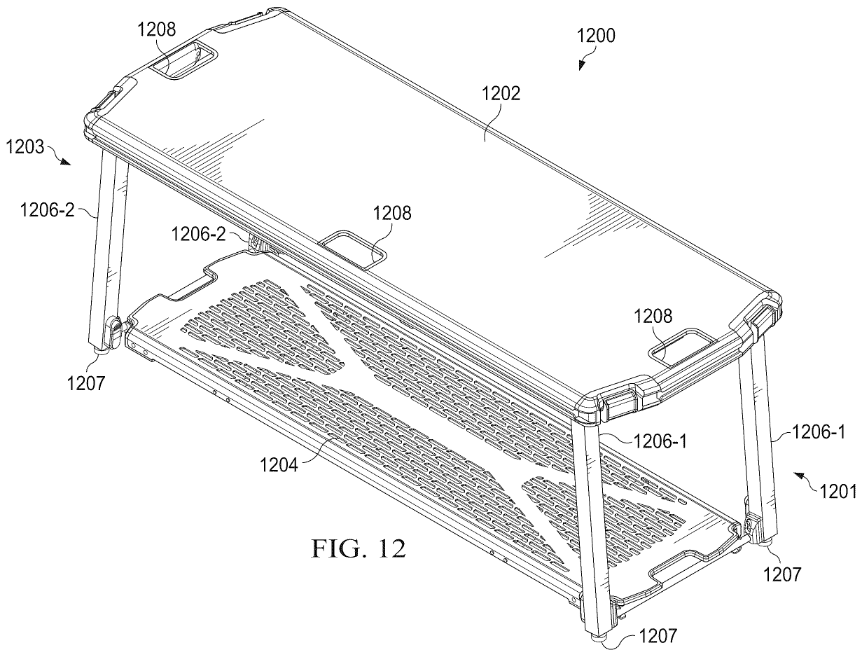

Turning to FIG. 12, an alternate embodiment of a table 1200 in accordance with the disclosed principles is depicted in a deployed bench configuration. The table 1200 has a first portion (or upper part) 1202, a second portion (or lower part) 1204, a first set of legs 1206-1, and a second set of legs 1206-2. In the deployed configuration, the first set of legs 1206-1 extend in a first direction from a first end 1201 of the bottom surface of the first portion 1202, and the second set of legs 1206-2 extend in the first direction from a second end 1203 of the bottom surface of the first portion 1202.

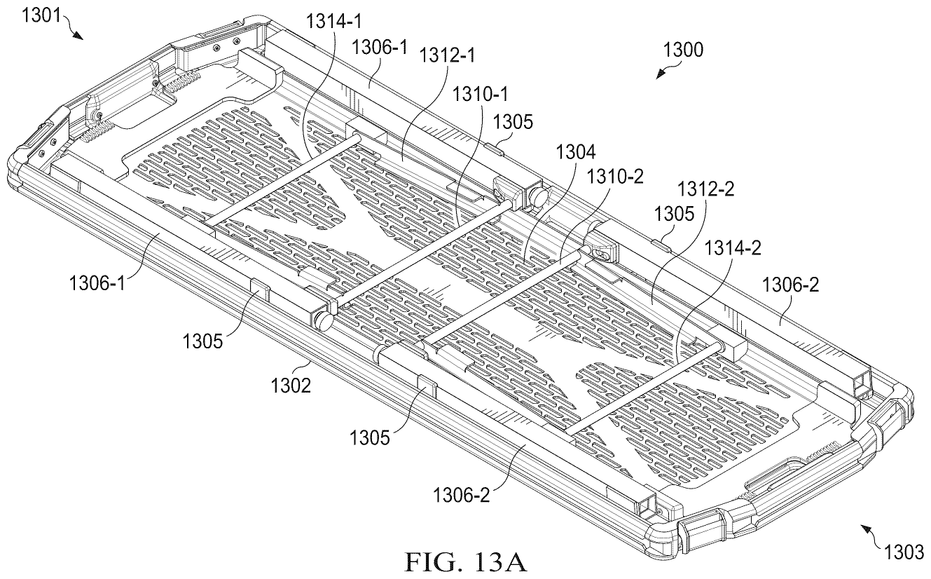

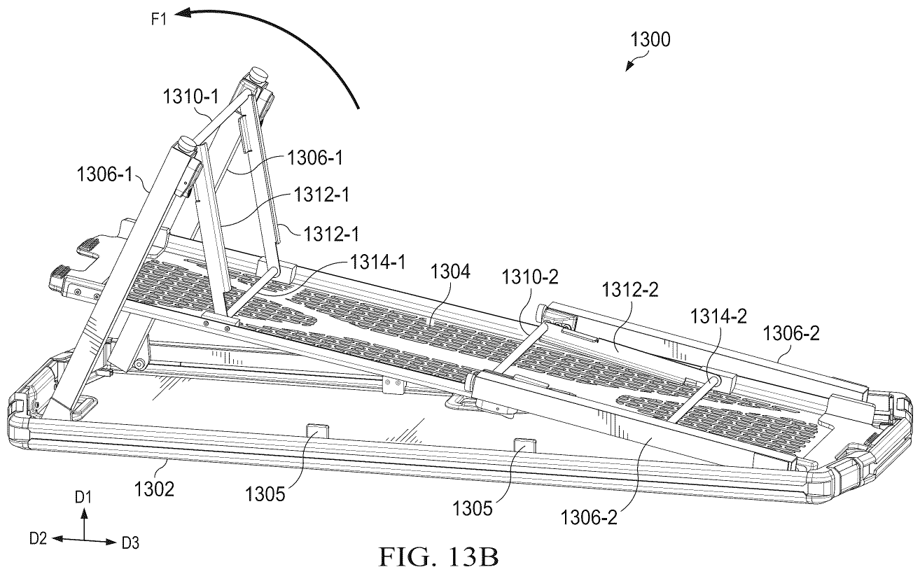

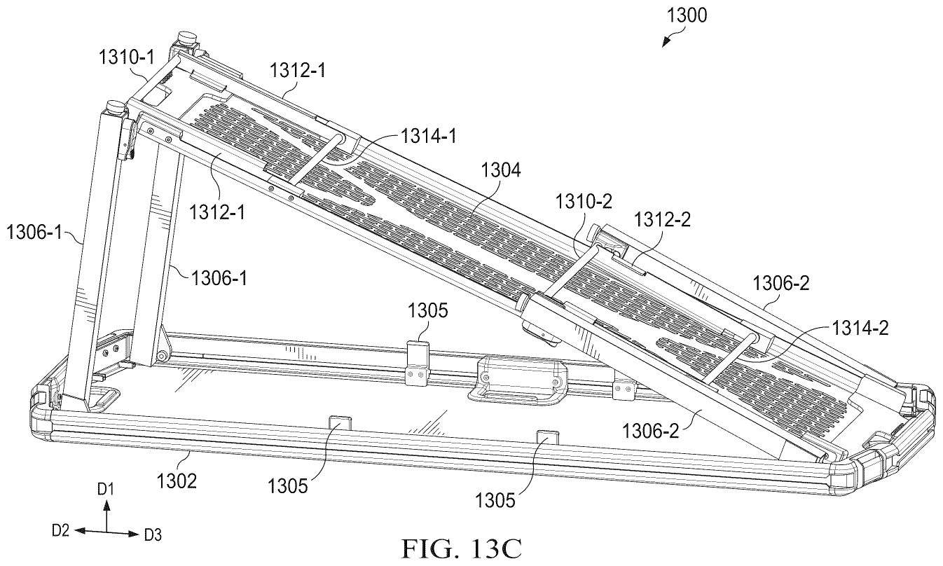

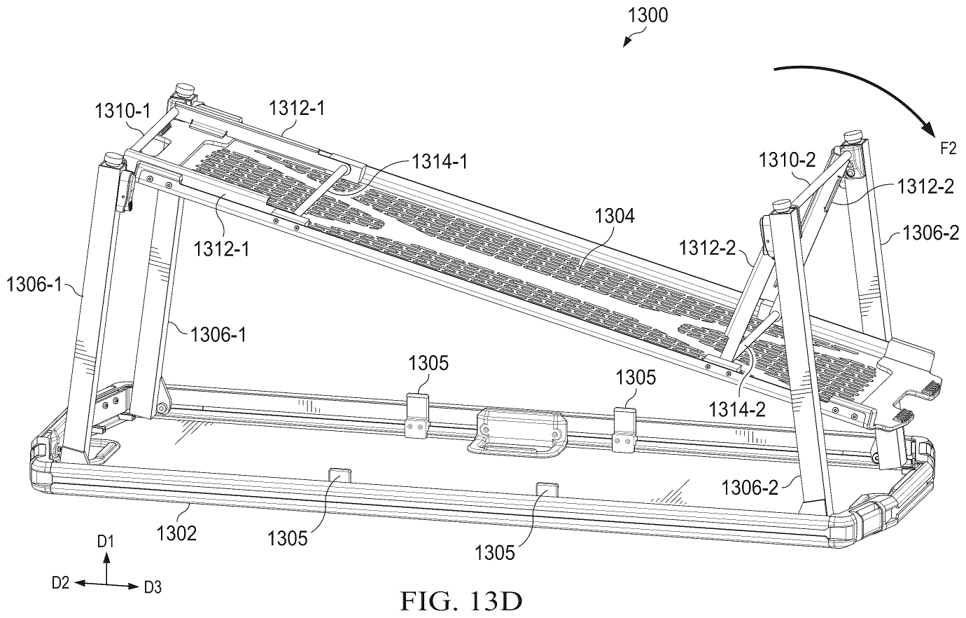

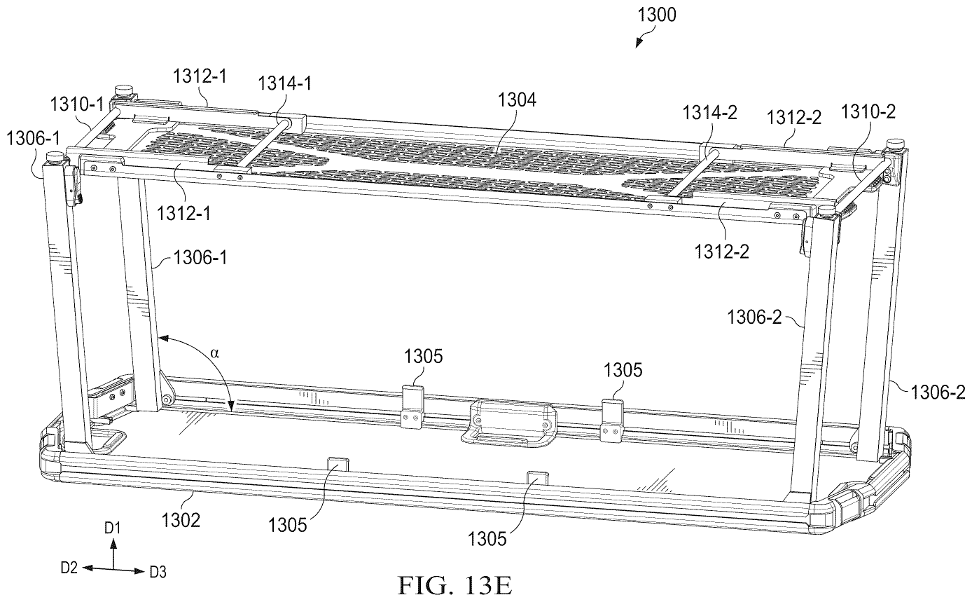

As discussed in more detail below, when the first and second sets of legs 1206-1, 1206-2 are extended in the first direction (see D1 of FIG. 13B), their collective movement causes the lower portion 1204 of the table 1200 to move way from the upper portion 1202 to it's lowered, deployed position. Each leg of the first set of legs 1206-1 and the second set of legs 1206-2 can have an extendible lower leg portion (not shown, but shown and described below). Each of these extendible lower leg portions may be stored within, and thus extend from, the sets of legs 1206-1, 1206-2. Additionally, each such extendible lower leg portion may be configured to lock in one or more extended positions. Specifically, each such lockable extended positions results in the lower leg portion extending from the sets of legs 1206-1, 1206-2 a predetermined distance. Each such extended distance thus provides a corresponding height to the table 1200 with the lower leg portions are extended. Each leg of the first set of legs 1206-1 and the second set of legs 1206-2 can have an adjustable foot 1207 that is configured to provide a level (or substantially level) orientation. The first portion 1202 can also include one or more receiving holes 1208 that are configured to promote a user grasping the table (e.g., as a handle) or receiving a receptacle for storing items.

Turning to FIGS. 13A-13E (collectively FIG. 13), a table 1300 transitioning from a collapsed configuration to a deployed configuration is depicted. In FIG. 13A, the table 1300 is in a collapsed configuration. When in their fully collapsed or stowed position, the first set of legs 1306-1 and the first set of arms 1312-1 are extending in a third direction (e.g., toward the second end 1303) such that the first set of legs 1306-1 are adjacent to, and thus rested along, the first portion 1302 of the table 1300. Similarly, the first set of arms 1312-1 are adjacent to, and thus rested along, the second portion 1304 of the table 1300. The second set of legs 1306-2 and the second set of arms 1312-2 are extended in the second direction (e.g., toward the first end 1301) such that the second set of legs 1306-2 are adjacent to, and thus rested along, the first portion 1302 of the table 1300, and the second set of arms 1312-2 are adjacent to, and as illustrated still resting along, the second portion 1304 of the table 1300. As such, when the table 1300 is in its fully collapsed or stowed configuration, the first set of legs 1306-1 and the second set of legs 1306-2 are substantially parallel to each other, and adjacent along the bottom surface of the first portion 1302 of the table 1300.

In FIG. 13B, the first set of legs 1306-1 have been partially moved away from the second portion 1304 and towards their deployed position by a user applying a first pulling force F1 on the first cross bar 1310-1 such that the first set of legs 1306-1 rotate at hinges at the bottom surface of the first portion 1302 to extend in the first direction D1 (e.g., normal to the first portion 1302) from the bottom surface of the first portion 1302. As the first set of legs 1306-1 rotate towards and eventually into the first direction D1, the first set of arms 1312-1 that are coupled to the first cross bar 1310-1 at a first end of the first set of arms 1312-1 rotate at a second end of the first set of arms 1312-1 coupled to a bottom surface of the second portion 1304 to extend in the second direction D2 such that they are again adjacent to the bottom surface of the second portion 1304. In this regard, the first set of arms 1312-1 begin in the fully collapsed configuration of the table 1300 lying adject to the bottom surface of the second portion 1304 of the table 1300 with their first ends pointed in the third direction D3.

Then, as illustrated in FIG. 13C, the first set of arms 1312-1 finish in the fully deployed configuration of the table 1300 again lying adjacent to the bottom surface of the second portion 1304, but with their first ends now pointed in the second direction D2. Thus, in their 180 degree rotation about the first cross bar 1310-1, their connection at their second end to hinges on the bottom surface of the second portion 1304 cause the second portion to move in the first direction D1 away from the first portion 1302 of the table 1300. More specifically, the first set of arms 1312-1 can be coupled together at their second end via a third cross bar 1314-1, which is rotatably coupled to the bottom surface of the second portion 1304. Alternatively, each end of the first set of arms 1312-1 can be directly rotatably coupled to the bottom surface of the second portion 1304 without the third cross bar 1314-1. As the user applies the first pulling force F1, the second portion 1204 begins to raise at the first end 1301 of the table 1300 such that the second portion 1304 is no longer engaged with the retaining clips 1305 of the first portion 1302. The retaining clips 1305 can be used to secure the first portion 1302 and the second portion 1304 together when the table 1300A is in the collapsed configuration. Thus, as shown in FIG. 13C, the first end 1301 of the second portion 1304 of the table 1300 is in its fully deployed position, while the second set of arms 1306-2 is still in its fully collapsed position.

Turning to FIGS. 13D-13E, a user applies a second pulling force F2 on the second cross bar 1310-2 such that the second set of legs 1306-2 rotate at hinges on the bottom surface of the first portion 1302 to rotate towards the first direction D1 from the bottom surface of the first portion 1302. As the second set of legs 1306-2 rotate towards the first direction D1, the second set of arms 1312-2 that are coupled to the second cross bar 1310-2 at a first end of the second set of arms 1312-2 rotate at a second end of the second set of arms 1312-2 coupled to the bottom surface of the second portion 1304 towards the third direction D3 such that they are again adjacent to the bottom surface of the second portion 1304 when in their fully deployed position. Like the first set of arms 1312-1, the second set of arms 1312-2 can be coupled together at their second end via a fourth cross bar 1314-2, which is rotatably coupled to the bottom surface of the second portion 1304. Alternatively, each end of the second set of arms 1312-2 can be rotatably coupled to hinges on the bottom surface of the second portion 1304.

As the user applies the second pulling force F2, the second portion 1304 begins to rise at the second end 1303 of the table 1300 such that the second portion is in a raised position where the second portion 1304 is parallel (or substantially parallel) to the first portion 1302 when the second set of legs 1306-2 and the second set of arms 1312-2 are moved to their fully deployed positions, as illustrated in FIG. 13E. As depicted in the illustrative embodiment, it can be advantageous to configure the first set of legs 1306-1 and the second set of legs 1306-2 to have an angle (α) that is more than 90° from the bottom surface of the first portion 1302 to increase the stability of the first set of legs 1306-1 and the second set of legs 1306-2. For example, in the deployed configuration, the second portion 1304 can be configured such that the second portion 1304 applies an outward force in the second direction D2 on the first set of legs 1306-1 and in the third direction D3 on the second set of legs 1306-2 to create the more than 90° angles that prevent the first set of legs 1306-1 and the second set of legs 1306-2 from buckling inward and collapsing the table 1300.

Alternatively or additionally, securing mechanisms may be included at opposing ends of the bottom surface of second portion 1304 to secure the first and second sets of arms 1312-1, 1312-2 to the bottom of the second portion 1304. In some embodiments, the securing mechanisms may provide a friction fit to secure the first and second sets of arms 1312-1, 1312-2. In other embodiments, the securing mechanisms may comprise magnets configured to attract and thereby secure corresponding magnetic pads on the first and second sets of arms 1312-1, 1312-2 to secure them to the bottom of the second portion 1304. In still other embodiments, the securing mechanisms may comprise pins or other fasteners to secure the first and second sets of arms 1312-1, 1312-2 to the bottom of the second portion 1304.

Once the first and second sets of legs 1306-1, 1306-2 are in their fully deployed position, and thus the table 1300 is in its fully deployed configuration, leg extension (not illustrated) may be extended from the distal ends of the first and second sets of legs 1306-1, 1306-2 to raise the deployed height of the table 1300. As discussed above, such leg extensions may be configured to lock or otherwise be secured in multiple lengths of extension, thereby providing varying height to the table 1300.

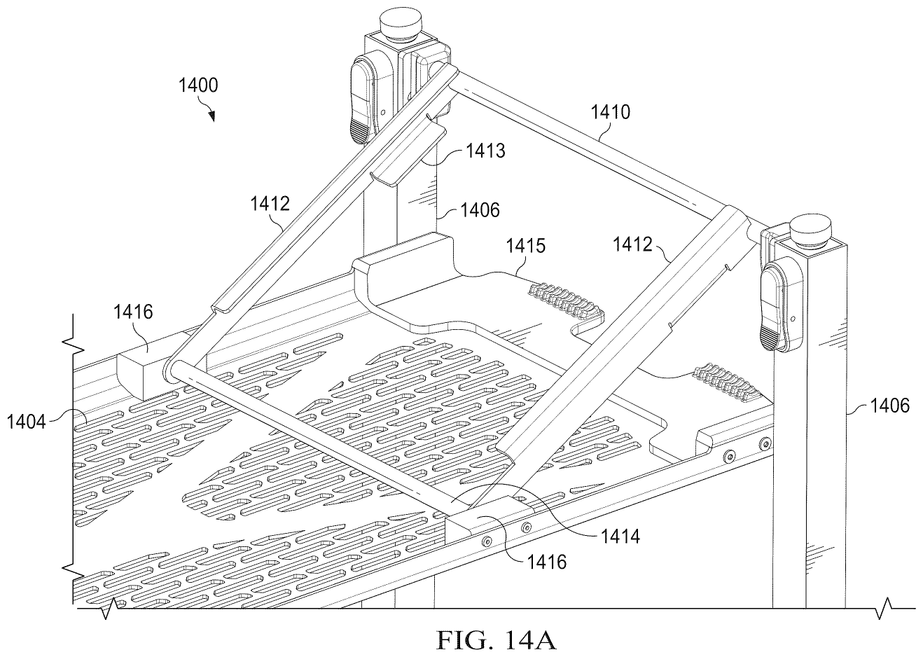

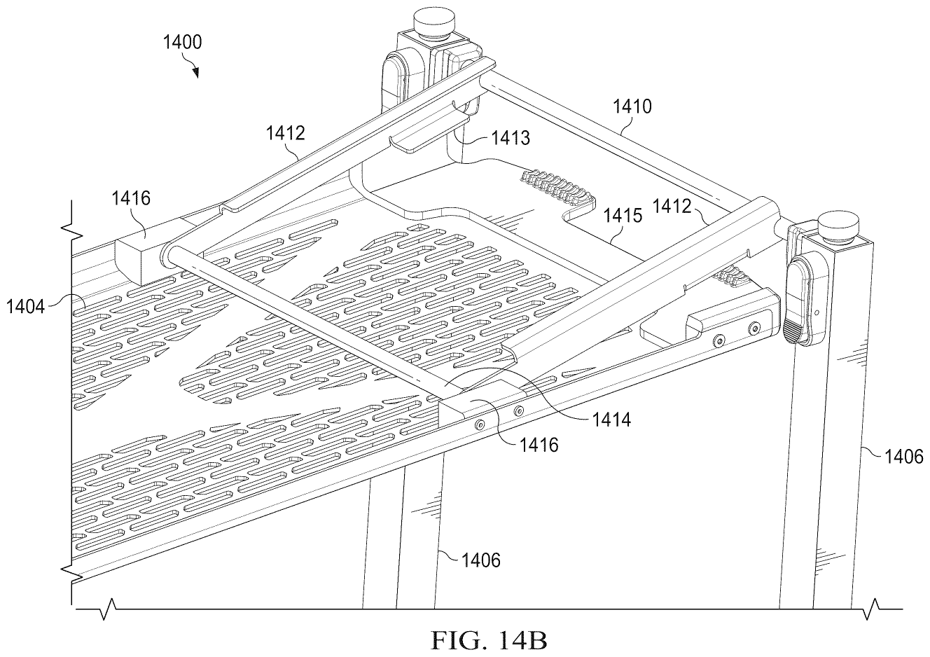

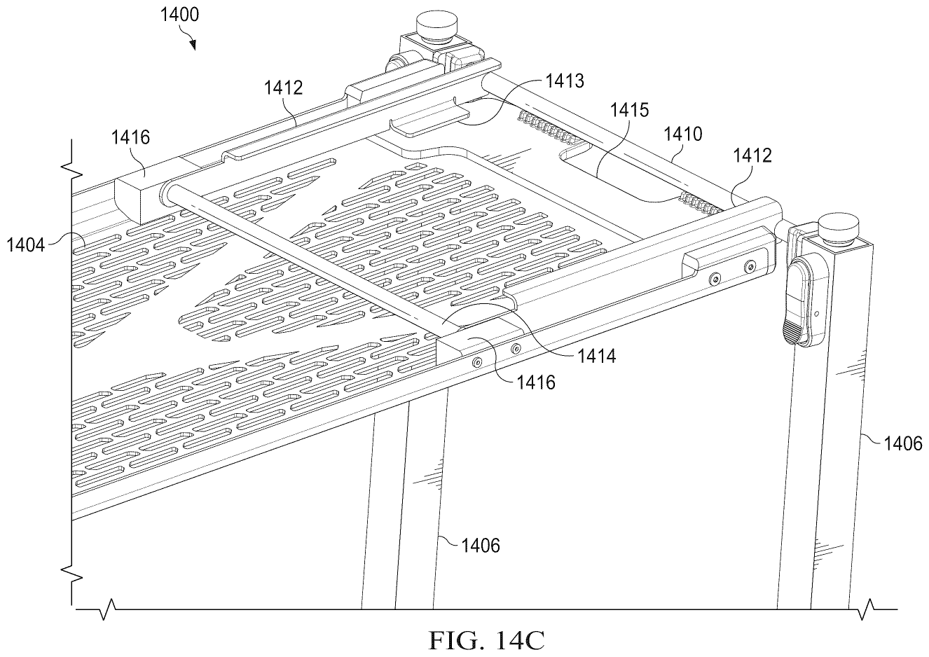

With reference to FIGS. 14A-14C, an engagement between a set of arms 1412 and the second portion 1404 of another exemplary table 1400 as disclosed herein is illustrated. In the illustrative embodiment, as the first cross bar 1410 interconnecting a set of legs 1406 rotates outwardly toward the proximal end of the table 1400, the set of arms 1412 rotate at the bottom of the second portion 1404 via a second cross bar 1414 toward the second, distal end of the table 1400.

In the illustrative embodiment, the second cross bar 1414 is rotatably connected to a pair of housings 1416 coupled on outer edges of the bottom of the second portion 1404. It can be advantageous to include a second crossbar 1414 between the set of arms 1406 to increase the stability of the table 1400. For example, the second crossbar 1414 and housings 1416 can prevent the second portion 1404 from shifting (or oscillating) when the first cross bar 1410 is rotated between collapsed and deployed positions. Additionally, the second crossbar 1414 and housings 1416 can increase the support when a load is applied to the table 1400 (e.g., prevent the legs 1406 from buckling). However, as noted herein, each arm of the set of arms 1412 can alternatively be rotatably connected directly to the edges of the bottom surface of the second portion 1404 via a fastener (e.g., nut and bolt).

The table 1400 can be configured to magnetically secure the set of arms 1412 to the bottom of the second portion 1404 when in their fully deployed position. For example, an area of the bottom of the second portion 1404 can have a one or a pair of magnets 1415 that is/are configured to magnetically couple to a ferrous tab 1413 mounted on the set of arms 1412 proximate the ends coupled to the first cross bar 1410. In the illustrative embodiment, the securing area of the second portion 1404 has two magnets 1415 that are configured to magnetically couple to corresponding ferrous tabs 1413 on each arm of the set of arms 1412. Additionally, or alternatively, the magnet (or plurality of magnets) can be configured to magnetically couple to the first cross bar 1410. The configuration of the magnet and ferrous material can vary so long as they work to secure the set of arms 1412 to the second portion 1404 when the table 1400 is in its fully deployed configuration.

Alternatively, the table 1400 can be configured with alternative securing mechanisms. For example, the bottom of the second portion 1404 can have an engagement interface 1415 that is configured to mechanically secure to a portion 1413 of the set of arms 1412. In one example, the portion 1413 of the set of arms 1412 can be press-fit into the engagement interface 1415 to secure the set of arms 1412 to the second portion 1404. Although only one end of the table 1400 is depicted with the securing means, it us understood that both ends can have a corresponding configuration.

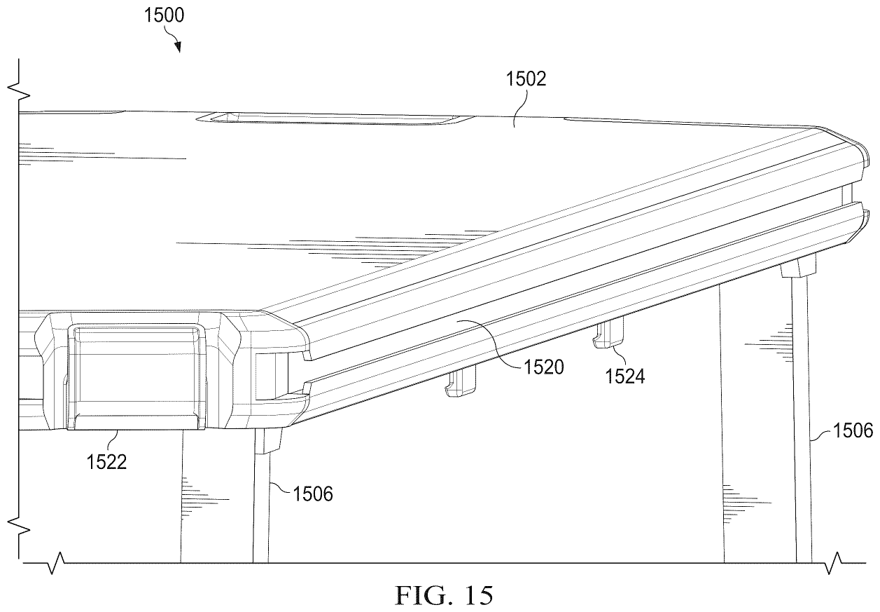

Turning to FIG. 15, an offset side view of another table 1500 in accordance with the disclosed principles is shown. The table 1500 is in a deployed configuration with its plurality of legs 1506 extended in the first direction D1 referenced above, and the second portion 1504 in a substantially parallel orientation to the first portion 1502 when deployed.

The first portion 1502 of the table 1500 can have at least one lateral surface that includes a railing 1520 configured to receive an engagement interface (not illustrated). For example, the railing 1520 can be configured to accept an engagement interface that is sized and configured to slide within the railing 1520, and thus positionable at any point along the length of the railing 1520. In a specific embodiment, the railing 1520 is provided as a T-slot, but other sizes, shapes and configurations for the railing 1520 are also employable. The engagement interface(s) can be connected to an object that supports items. For example, the object connected to an engagement interface can be a magnet that secures ferrous tools (e.g., knives) to the table 1500 for quick access. The object can also be a receptacle that is configured to hold tools or utensils. The first portion 1502 can also include an engagement interface that is configured to support an object. Additionally, the first portion 1502 can include one or more hooks extending from the bottom of the first portion 1502 and configured to suspend an object.

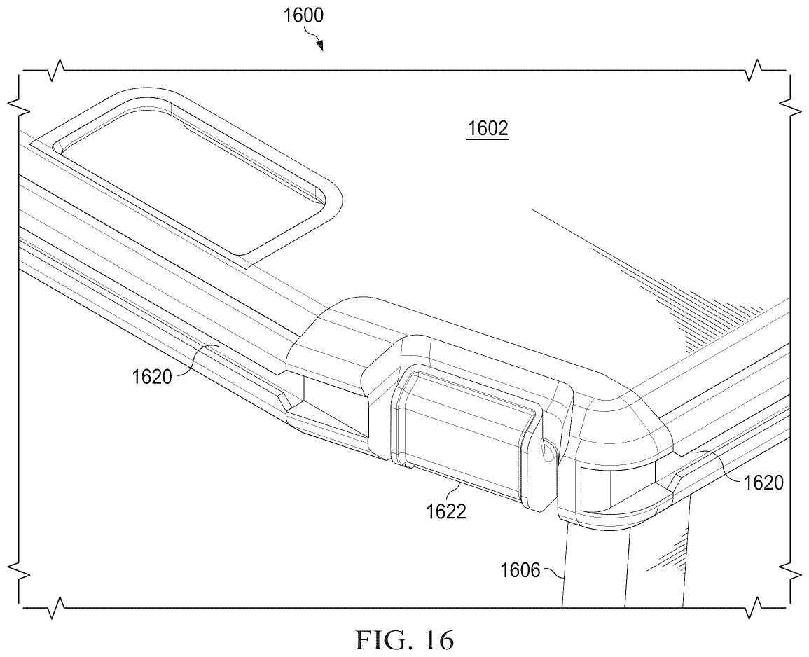

Referring to FIG. 16, an offset front view of another embodiment of a table 1600 in accordance with the disclosed principles is shown. The table 1600 is in a deployed configuration with the plurality of legs 1606 extended in the first direction D1 referenced above, and its second portion 1604 in a substantially parallel orientation to its first portion 1602. In the illustrative embodiment, the first portion 1602 has multiple lateral surfaces with railings 1620, which in this embodiment are shaped as T-slots, and one of the lateral surfaces has an engagement interface 1622. The engagement interface 1622 is configured to support an object. In exemplary embodiments, the engagement interface 1622 is sized and shaped to receive and hold a bag that is suspended from the engagement interface 1622 via its handles being secured around and in a channel formed in the engagement interface 1622. In one embodiment, the lateral surface has an engagement interface 1622 at each end, allowing a receptacle (e.g., a trash bag) to be suspended from the table 1600. In other embodiments, the lateral surface has an engagement interface 1622 proximate each corner of the lateral surface of the first portion 1602, thus permitting suspension of four distinct items or objects. In embodiments like the embodiment illustrated in FIG. 16, a pair of engagement interfaces 1622 can be provided at the ends of the lateral surface, thereby leaving the railings 1602 unobstructed and thus fully useable with engaging objects sized and configured to be secured within and along the railings 1602.

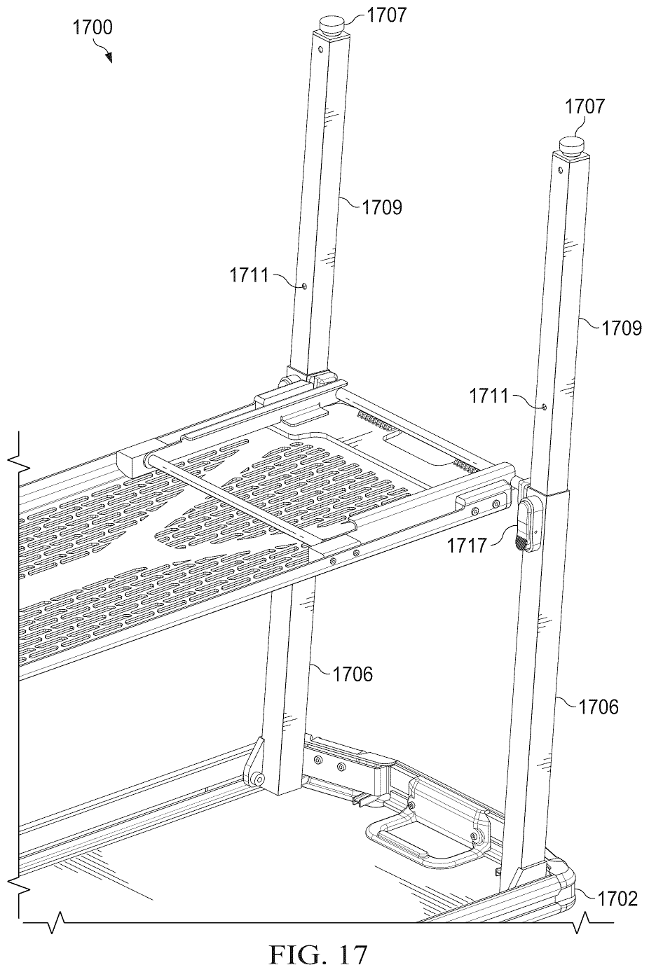

Referring to FIG. 17, another embodiment of a table 1700 as disclosed herein is illustrated in an upside down orientation. The table 1700 is shown in a fully deployed configuration, with the top surface of the first portion 1702 placed against a workplace surface. The plurality of legs 1706 are extended in the first direction D1, and telescoping extension portions 1709 of the legs 1706 are shown in fully extended positions. The telescoping extension portions 1709 can have a plurality of apertures 1711 formed along their length to allow the overall height of the legs 1706 of the table 1700 to be adjusted. In this illustrative embodiment, the apertures 1711 are configured to engage with a retractable pin 1717 to secure the telescoping extension portions 1709 at a particular height. The extension portions 1709 also have adjustable feet 1707 that promote stability and/or leveling of the table 1700.

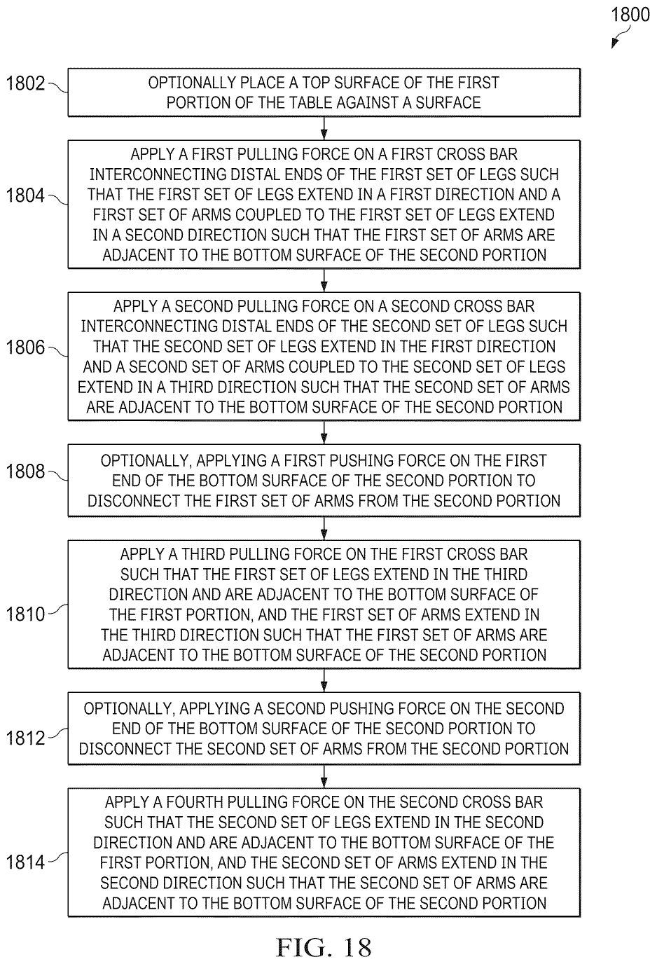

Referring now to FIG. 18, there is provided a flow diagram of an illustrative method 1800 for deploying and collapsing various embodiments of a table in accordance with tables 1200-1700 in FIGS. 12-17. The table can have a first portion providing its upper lateral surface, a second portion providing a lower lateral surface, and a first set of legs and second set of legs both pivotally coupled to the bottom surface of the first portion at their proximal ends. Also, the table includes first and second sets of arms pivotally coupled at their distal ends to the first and second sets of legs, respectively, as well as pivotally coupled at their proximal ends to the bottom surface of the second portion.

Method 1800 begins at 1802 where a user optionally places a top surface of the first portion of the table onto a surface for ease of operation. At 1804, the user applies a first pulling force on a first cross bar interconnecting distal ends of the first set of legs such that the first set of legs rotate at the bottom surface of the first portion to extend in a first direction perpendicular to the bottom surface of the first portion. A first set of arms coupled at their distal ends to the first cross bar, and which begin adjacent to a bottom surface of the second portion, are then caused to rotate at their proximal ends that are coupled to the bottom surface of the second portion to extend in a second direction, parallel to the first and second portions, such that the first set of arms, after rotating approximately 180 degrees, are again adjacent to the bottom surface of the second portion. Optionally, an engaging feature on one or both of the first set of arms couples with a receiving mechanism at a first end of the second portion.

At 1806, the user applies a second pulling force, opposite to the first pulling force, on a second cross bar interconnecting distal ends of the second set of legs such that the second set of legs rotate at the bottom surface of the first portion to extend in the first direction that is perpendicular to the bottom surface of the first portion. A second set of arms coupled their distal ends to the second cross bar, and which also begin adjacent to a bottom surface of the second portion, are then caused to rotate at their proximal ends that are coupled to the bottom surface of the second portion to extend in a third direction, opposite to the second direction, such that the second set of arms, after rotating approximately 180 degrees, are again adjacent to the bottom surface of the second portion. The application of the first and second pulling forces thereby place the table in the deployed configuration. Optionally, an engaging feature on one or both of the second set of arms couples with a receiving mechanism at a second end of the second portion. Steps 1802-1806 are thus performed to transform the table from its collapsed configuration to its deployed configuration. Optionally, the user extends telescoping parts of the first and second sets of legs to adjust the height of the deployed table.

To convert the table from its deployed configuration back to its collapsed configuration, if the user extended telescoping parts of the first and second sets of legs to adjust the height of the deployed table, those telescoping leg extensions are first slid back into the first and second sets of legs. At 1808, the user optionally applies a first pushing force on the first end of the bottom surface of the second portion towards the first portion, thereby disconnecting the coupling between engaging feature(s) on the first set of arms and the receiving mechanism on the first end of the second portion. At 1810, the user applies a third pulling force on the first cross bar such that the first set of legs rotate at the bottom surface of the first portion to extend in the third direction until the first set of legs are left lying adjacent to the bottom surface of the first portion in a collapsed position. The first set of arms are thereby rotated at their proximal ends to extend in the third direction such that the first set of arms, after rotating approximately 180 degrees, are again adjacent to the bottom surface of the second portion at their starting, collapsed position.

At 1812, the user optionally applies a second pushing force on the second end of the bottom surface of the second portion towards the first portion, thereby disconnecting the coupling between the engaging feature(s) on the second set of arms and the receiving mechanism on the second end of the second portion. At 1814, the user applies a fourth pulling force on the second cross bar such that the second set of legs rotate at the bottom surface of the first portion to extend in the second direction until the second set of legs are left lying adjacent to the bottom surface of the first portion in their collapsed position. The second set of arms are thereby rotated at their proximal ends to extend in the second direction such that the second set of arms, after rotating approximately 180 degrees, are again adjacent to the bottom surface of the second portion at their starting, collapsed position. The application of the third and fourth pulling forces thereby place the table in its collapsed configuration.

Exemplary embodiments described herein may use the term surface to describe components of the table. The term surface is not limited to just the surface but may include the structure defining the surface. For example, the top surface may include the tabletop structure in which the top surface is apparat. Accordingly, when the top surface is described as contacting another structure, such as the legs and/or lower surface, the contact may be to any structure part of the top surface, including, for example, the lower side of the structure that defines the top surface.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

When used in this specification and claims, the terms “comprises” and “comprising” and variations thereof mean that the specified features, steps or integers are included. The terms are not to be interpreted to exclude the presence of other features, steps or components.

1.-23. (canceled)

24. A table comprising:
a first portion having a top surface and a bottom surface;
a second portion having a top surface and a bottom surface;
a first set of legs rotatably coupled at their proximal ends to a first end of the bottom surface of the first portion, wherein the first set of legs are coupled together at their distal ends via a first cross bar;
a second set of legs rotatably coupled at their proximal ends to a second end of the bottom surface of the first portion, wherein the second set of legs are coupled together at their distal ends via a second cross bar;
a first set of arms coupled to the first cross bar at their distal ends, and rotatably coupled to the bottom surface of the second portion at their proximal ends; and
a second set of arms coupled to the second cross bar at their distal ends, and rotatably coupled to the bottom surface of the second portion at their proximal ends;
wherein the table is in a deployed configuration when:
the first set of legs extend in a first direction away from the bottom surface of the first portion, and the first set of arms extend in a second direction, parallel to the bottom surface of the second portion, and are adjacent to the bottom surface of the second portion, and
the second set of legs extend in the first direction from the bottom surface of the first portion, and the second set of arms extend in a third direction, opposite to the second direction, and are adjacent to the bottom surface of the second portion,
wherein the first and second sets of legs extending in the first direction positions the second portion horizontally distant from the first portion; and
wherein the table is in a collapsed configuration when:
the first set of legs extend in the third direction and are adjacent to the bottom surface of the first portion, and the first set of arms extend in the third direction and are adjacent to the bottom surface of the second portion, and
the second set of legs extend in the second direction and are adjacent to the bottom surface of the first portion, and the second set of arms extend in the second direction and are adjacent to the bottom surface of the second portion,
wherein the first set of legs extending in the third direction and the second sets of legs extending in the second direction positions the second portion horizontally adjacent to the first portion.

25. The system of claim 24, wherein the bottom surface of the second portion comprises an engagement interface configured to secure the distal ends of the first set of arms, the distal ends of the second set of arms, or a combination thereof to the second portion in the deployed configuration.

26. The system of claim 25, wherein the engagement interface comprises at least one magnet and wherein one or more of the distal ends of the first and second sets of arms comprises a ferrous material.

27. The system of claim 25, wherein the bottom surface of the second portion comprises a first engagement interface at its first end and a second engagement interface at its second end, wherein the first engagement interface is configured to secure the distal ends of the first set of arms, and wherein the second engagement interface is configured to secure the distal ends of the second set of arms.

28. The system of claim 27, wherein the first engagement interface comprises a first set of magnets corresponding to the distal ends of the first set of arms, and the second engagement interface comprises a second set of magnets corresponding to the distal ends of the second set of arms.

29. The system of claim 28, wherein the distal ends of the first set of arms comprises a ferrous portion configured to magnetically couple to the first set of magnets, and the distal ends of the second set of arms comprises a ferrous potion configured to magnetically couple to the second set of magnets.

30. The system of claim 27, wherein the first engagement interface comprises a first press-fit mechanism configured to receive a portion of the distal ends of the first set of arms, and the second engagement interface comprises a second press-fit mechanism configured to receive a portion of the distal ends of the second set of arms.

31. The system of claim 24, wherein each leg of the first and second sets of legs comprises telescoping extensions configured to extend from distal ends of the legs to adjust a height of the legs.

32. The system of claim 24, wherein the first and second sets of legs are oriented at more than 90° from the bottom surface of the first portion in the deployed configuration.

33. The system of claim 24, wherein the first set of arms are rotatably coupled to the bottom surface of the second portion via a third cross bar, and the second set of arms are rotatably coupled to the bottom surface of the second portion via a fourth cross bar.

34. The system of claim 24, wherein one or more lateral surfaces of the first portion comprise a railing configured to receive an engagement interface.

35. The system of claim 34, wherein the railing comprises a T-slot extending along at least a portion of the one or more lateral surfaces.

36. The system of claim 34, wherein the first portion comprises one or more apertures formed from its top surface to its bottom surface, and configured for receiving a receptacle therethrough.

37. The system of claim 24, wherein one or more lateral surfaces proximate the first and second ends of the first portion comprise an engagement interface having a channel configured support a receptacle.

38. A method of operating a table between a collapsed configuration and a deployed configuration, the table having a first portion, a second portion, a first set of legs coupled to the first portion, a second set of legs coupled to the first portion, a first set of arms coupled to the first set of legs, and a second set of arms coupled to the second set of legs, the method comprising:
applying a first pulling force on a first cross bar interconnecting distal ends of the first set of legs such that the first set of legs rotate at a bottom surface of the first portion to extend in a first direction perpendicular to the bottom surface of the first portion;
wherein, in response to the first pulling force, the first set of arms coupled at their distal ends to the first cross bar, and wherein said first set of arms begin adjacent to a bottom surface of the second portion, are then caused to rotate at their proximal ends that are coupled to the bottom surface of the second portion to extend in a second direction, parallel to the first and second portions, such that the first set of arms, after rotating approximately 180 degrees, are again adjacent to the bottom surface of the second portion;
applying a second pulling force, opposite to the first pulling force, on a second cross bar interconnecting distal ends of the second set of legs such that the second set of legs rotate at a bottom surface of the first portion to extend in the first direction;
wherein, in response to the second pulling force, the second set of arms coupled at their distal ends to the second cross bar, and wherein said second set of arms begin adjacent to the bottom surface of the second portion, are then caused to rotate at their proximal ends that are coupled to the bottom surface of the second portion to extend in a third direction, opposite to the second direction, such that the second set of arms, after rotating approximately 180 degrees, are again adjacent to the bottom surface of the second portion; and
wherein application of the first and second pulling forces thereby horizontally spaces the second portion from the first portion.

39. The method of claim 38, wherein the first portion and second portion are substantially parallel prior to and after application of the first and second pulling forces.

40. The method of claim 38, wherein, in response to the first pulling force, distal ends of the first set of arms are coupled to a retaining mechanism at a first end of the bottom surface of the second portion, and, in response to the second pulling force, distal ends of the second set of arms are coupled to a retaining mechanism at a second end of the bottom surface of the second portion.

41. The method of claim 40, further comprising:
applying a third pulling force, opposite to the first pulling force, on the first cross bar such that the first set of legs rotate at the bottom surface of the first portion to extend in the third direction until the first set of legs are left lying adjacent to the bottom surface of the first portion in a collapsed position;
wherein, in response to the third pulling force, the first set of arms are thereby rotated at their proximal ends to extend in the third direction such that the first set of arms, after rotating approximately 180 degrees, are again adjacent to the bottom surface of the second portion at their started, collapsed position; and
applying a fourth pulling force, opposite to the second pulling force, on the second cross bar such that the second set of legs rotate at the bottom surface of the first portion to extend in the second direction until the second set of legs are left lying adjacent to the bottom surface of the first portion in a collapsed position;
wherein, in response to the fourth pulling force, the second set of arms are thereby rotated at their proximal ends to extend in the second direction such that the second set of arms, after rotating approximately 180 degrees, are again adjacent to the bottom surface of the second portion at their started, collapsed position.

42. The method of claim 41, further comprising:
prior to applying the third pulling force, applying a first pushing force on the first end of the bottom surface of the second portion and towards the first portion, thereby disconnecting the coupling between the retaining mechanism and the distal ends of the first set of arms; and
prior to applying the fourth pulling force, applying a second pushing force on the second end of the bottom surface of the second portion and towards the first portion, thereby disconnecting the coupling between the retaining mechanism and the distal ends of the second set of arms.

43. The method of claim 38, further comprising after applying the first pulling force and the second pulling force, extending telescoping extensions from distal ends of each leg of the first and second sets of legs.
